(19) United States
(12) Patent Application Publication
(10) Pub. No.: US 2007/0244780 A1
(43) Pub. Date: Oct. 18, 2007

(54) Real estate derivative financial products, index design, trading methods, and supporting computer systems

(76) Inventor: Ralph Y. Liu, Norco, CA (US)

Correspondence Address: Paul E Schaafsma;NovusIP, LLC, Suite 221, 521 West Superior Street, Chicago, IL, 60610-3135, US

(21) Appl. No.: 11/726,544

(22) Filed: Mar. 22, 2007

Related U.S. Application Data
(60) Provisional application No. 60/866,617, filed on Nov. 21, 2006.
(60) Provisional application No. 60/829,597, filed on Oct. 16, 2006.
(60) Provisional application No. 60/806,790, filed on Jul. 9, 2006.
(60) Provisional application No. 60/806,476, filed on Jul. 2, 2006.
(60) Provisional application No. 60/805,970, filed on Jun. 27, 2006.
(60) Provisional application No. 60/767,406, filed on Mar. 26, 2006.

(51) Int. Cl. G06Q 40/00

(52) U.S. Cl. 705/35

(57) ABSTRACT

In accordance with the principles of the present invention, real estate derivative financial products, index design, trading methods, and supporting computer systems are provided for property owners and investors to temporarily swap their respective economic interests in owning/disowning an underlying property for a certain period of time, directly or through some middlemen. Therefore in addition to the traditional ways of either buying/selling or renting property, the property owner could consider a third new way of dealing with a property. The present invention provides a very straightforward way to enable property owners to protect the gains or prevent further losses in their property equity value. On another hand, the present invention also allows investors to establish an exposure in a potential property equity appreciation or depreciation in a particular neighborhood.

### RELATED APPLICATIONS

This application is based upon U.S. Provisional Patent Application No. 60/886,617 titled “Property or Real Estate Index Linked Notes, Bonds or Deposits and Their Manufacturing, Trading, Hedging and Marketing Methods” filed 25 Jan. 2007; U.S. Provisional Patent Application No. 60/829,597 titled “Pricing and Trading Methods of Real Estate Index Options and other related Property Derivatives” filed 16 Oct. 2006; U.S. Provisional Patent Application No. 60/806,790 titled “Future Value Choice Mortgage (FVCM) and its inherent Real Estate Options’ Trading Methods (REIO)” filed 9 Jul. 2006; U.S. Provisional Patent Application No. 60/806,476 titled “Property Equity Locking Mortgages or Home Equity Locking Mortgages” filed 2 Jul. 2006; U.S. Provisional Patent Application No. 60/805,970 titled “SwapRent—The New Alternative Transaction for Property Investors” filed 27 Jun. 2006U.S. Provisional Patent Application No. 60/767,406 titled “Real Estate Index Derivatives Exchange (REIDEX)” filed 26 Mar. 2006.

### FIELD OF THE INVENTION

The present invention relates to a new alternative between buying/selling and the renting of real estate property.

### BACKGROUND OF THE INVENTION

The American real estate market is currently the world's largest financial market. The total value of residential real estate alone is reaching 24 trillion dollars and growing; however, as sophisticated as the U.S. financial market is, the American homeowners up until now still cannot hedge the equity value in their homes adequately and properly. A home represents the largest single asset for most individuals, and the associated accumulated equity in the home constitutes a substantial part of their financial net worth. However, real estate is subject to price fluctuation, both upward and downward. Particularly downward price fluctuations can have a significant adverse effect upon the net worth of homeowners.

Currently, the only method available to a homeowner to lock in the gains or loss in the home equity value is to do a “sale and lease back” transaction. This includes a real estate sale transaction and the renting from the new owner of a house that the homeowner had been occupying. The high transactional cost as well as the tax and legal implications associated with this are usually the deterrents for homeowners to widely accept “sale and lease back” as a tool for the purpose of locking in the financial gains or loss for a specified period of time.

Although the housing market has been very strong in the past few years due to very low interest rates as well as many innovative payment-reducing mortgage products, the real estate prices at some point in the near future may start to decline. When that happens, the homeowners/investors will have no other way to protect the erosion of their asset value, other than selling the property outright; however, what is best for the households financially may not be the best for the family's overall welfare due to this disruption of forced sell-off and relocation.

At the present time, there is no efficient means for an individual homeowner to protect the value of the investment in his home when residential real estate values are declining. Traditionally, the homeowner either waits to sell his house when the real estate markets recover and the homeowner can make a profit on the sale, or if forced to move due to job changes or other relocation pressures, the homeowner sells at a loss. This is in contrast to the situation for other means to protect his investment, such as traditional insurance policies that cover destruction or damage to the house from a variety of causes.

High income or wealthy people can afford and would be interested in buying insurance for down-side property value risk protection. While there has been a market demand for many years for additional insurance coverage against market declines in house values, insurance companies have been reluctant to write such home-equity insurance policies for a variety of reasons. An insurance policy that directly protect against a decline in a particular value of a home is one of “moral hazard,” since many factors influencing the value of a home are under the direct control of the homeowner. If the homeowner fails to adequately maintain the house and property, or makes decorative or other changes that are idiosyncratic in nature, then a decline in the value of the property will inevitably result. Yet, it would be difficult for an insurance company to objectively prove under some default provision in the insurance policy what portion of the house's reduced sale price was due to these “homeowner controlled” factors. Thus, a homeowner with a home equity insurance policy would be temped to fail to maintain the property because the homeowner would face little financial risk.

Another problem is that buyers of homes who paid too much for the property would have a special incentive to take out a home equity insurance policy due to the probability that they could not sell the house for the same price, at least within the relatively near future. This is called the “adverse selection problem.” A home equity insurance policy would therefore place this risk squarely on the insurance company. Yet another problem would be a home equity insurance policy holder who neglected to make reasonable efforts to obtain market value for his house at the time of sale because they know the insurance company would make up the difference. These reasons have made home equity insurance policies unfeasible.

Low income or poor people do not worry so much of the downside property value risk as much as do high income people because what they need is usually a shelter, a place to sleep. It does not matter much if the value declines as long as they have the ability to pay the monthly mortgage payments so that they can continue to stay in the house. Nor do they treasure the future uncertain potential upside appreciation as much as do rich people—they would rather treasure more cash at hands. Therefore this kind of clientele represents what constitutes the existing market demand for Shared Equity Mortgage (SEM), Shared Appreciation Mortgage (SAM) or even Reverse Mortgage and Home Equity Conversion Mortgage (HECM) markets in many parts of the world. It should be recognized that in the U.K., these carry different names such as Home Reversion Scheme, Life Time Mortgages and Home Income Plan, etc. Low income people, including senior and retired people, are more interested in current income than any future uncertain appreciation potential which may or may not even be realized. They would be interested in selling uncertain future appreciation potential so that they can get a monthly income which they could use for a mortgage payment subsidy or other purposes.

In many states or foreign countries (for example, the U.K. and Australia) the government usually sets up task force and incentive programs for non-profit or commercial entities to provide such an subsidies to potential homeowners so that the homes would be much more affordable. However, the current products offered to the consumers such as the SEM, SAM or Reverse Mortgages and HECM are not satisfactory because they do not offer the same economic benefits that derivatives could traditionally offer that would be much better than non-derivatives cash financial instruments could ever provide.

In addition, despite the sophistication of many areas of the financial markets, there is still no financial product specifically designed to help homeowners or commercial property owners and lenders protect the value of this significant asset class. Secondary financial products exist in virtually every sizable market and asset class and provide investors with alternative methods for investing and hedging their current position (e.g., the options market for equities, the futures market for commodities, and the treasuries markets for currencies). Derivatives markets such as futures exchanges as well as over-the-counter (OTC) swaps and options markets have been fully developed on most of the other types of financial or commodity markets for decades. Many industry participants and end users have been beneficiaries of the availability of such hedging instruments. In the risk management industry, the swaps markets usually represent the basic form at the top level of the food chain to offer the basic risk transferring capabilities in the OTC market. This is the case in equity market, interest rates market, energy or other soft or agro commodities market.

In addition to providing an efficient hedging tool against tangible real estate investments, there is a need to enable investors to synthetically invest in real estate. These investors may be interested in diversifying their institutional and individual portfolios to include real estate, which is not closely correlated to equities and many other investment vehicles, or they may be interested in balancing their real estate portfolio by investing in real estate in a disparate geographic region. To invest in real estate now, one must actually purchase the real estate. However, selling and buying real estate is an inherently inefficient and expensive process, making it exceedingly difficult for investors to efficiently invest capital in desirable real estate holdings. Furthermore, to truly diversify a commercial real estate investment portfolio, one would need to purchase different types of real estate in many different geographic markets, which would make the costs to execute such a real estate investment strategy exorbitant. Moreover, once purchased, such real estate holdings need to be maintained and managed, which can substantially further increase these costs.

An early instance of an attempt to provide such a financial instrument was a futures contract on residential real estate prices in the United Kingdom in May 1991 that was initiated by the London Futures and Options Exchange, which has since evolved into Euronext, Postbus 19163, 1000 GD, Amsterdam. Trading in this contract was promptly suspended in October 1991, however, when it became apparent that few homeowners were availing themselves of an exchange-based system, despite the presence of unstable residential real estate prices in England, and the exchange was required to artificially support trading values in the futures contract to mask this deficit in customer usage.

The real estate index derivative instruments that currently exist are generally classified into exchange-based futures and options for residential real estate and OTC market-based Total Return Swaps (TRS) and Price Return Swaps (PRS) for commercial real estate. ISDA refers to the International Swaps and Derivatives Association, which is a financial trade association with offices at 360 Madison Avenue, 16th Floor, New York, N.Y. 10017.

Based on an index of the desired regions, a real estate index derivative product of the present invention could be designed to correspond to the specific underlying index. The real estate index derivative products of the present invention can be offered in various maturities such as for example 1, 2, 3, . . . 5 and upwards to 10, 20 years or longer.

The most likely indexes could be at the neighborhood or town levels or even regional levels for less populated area. Examples are Upper East Side Manhattan, N.Y.; Gold Coast Chicago, Ill.; South Beach Miami, Fla.; 90210, California; Newport Beach, Calif.; Orange County, California or Western Montana etc. In one embodiment, the size of the real estate index derivative product could be one square foot. Trading hours could be established such as for example between 10:00 am. to 2:00 p.m. PST or for any time during any or the entire 24 hour a day. As explained in more detail below, orders could be initiated via phones, faxes or through a wide area network such as the Internet or a local area network such as an intranet. Trades could be electronically matched or privately negotiated. A typical bid/offer example could be something like 3.75%/3.5% for ZIP code area 90210 in the U.S. and for postal code area W1K 2HP for the U.K. with a corresponding per square foot weighted average or median price of $750 or a per square foot and weighted average or median price of £350.

Credit collateral could include cash, treasury securities for investors, a home equity line or the new mortgage products of the present invention property owners/hedgers described in detail below. In one embodiment, collateral requirements and other risk management methodologies can preferably be according to existing industry practice for OTC transactions. The collateral of a real estate index derivative product account for investors could be the deposit money for establishing a speculative position (similar to initial margin concept, could be 5, 10 or 20% for example). The positions could be marked-to-market on for example a daily, weekly, monthly or quarterly basis by for example the daily moving average or monthly settled indices. The gains or losses can be added to or offset by the value of the collateral. If the deposit money drops below a certain pre-specified level (similar to the variation margin A summary of the prior exchange-based futures and options contract design and business methods for residential properties in the U.S. is in an article in the Los Angeles Times, “Entrepreneur Sees a Futures Market for Homeowners” (Sunday, 20 Apr. 2003).

The Chicago Mercantile Exchange, 20 South Wacker Drive, Chicago, Ill. 60606 (CME) subsequently launched similar housing futures and options contracts in May 2006. As of the end of 2006, the CME has only done a $340 million notional amount of the 1500 trades for a $24 trillion underlying U.S. residential market. On the OTC markets side for commercial properties, in the United Kingdom, as of the end of 2006 there has been about a billion pounds of notional amount of TRS and PRS being done on Investment Property Databank's, 1 St John's Lane, London, EC1M 4BL, England (IPD) All Property Index (API) and other sub-indices after five years of experimenting since its inception in 2001. In the U.S., as of the end of 2006 two index swap trades have been done on the NPI (National Property Index) published by NCREIF (National Counsel for Real Estate Investment Fiduciaries) and arranged by Credit Suisse, Paradeplatz 8, 8070 Zurich, Switzerland. None of these experimental markets had generated sufficient momentum or critical mass to make it a success so far. Other attempts to utilize traditional disaster or calamity insurance concepts by putting up reserve such as those employed in the life or auto insurance industry have also not succeeded.

These concepts and first few instruments of TRS and PRS were originally borrowed from the OTC equity swaps market. When applied to the property markets, the TRS and PRS have many deficiencies. Due to the diverse regional or de-centralized nature of the real estate markets within many countries as well as the relatively unsophisticated nature of these residential real estate asset class owners as compared to the more financially savvy participants in the equity markets, it became apparent that the property markets definitely need new, more innovative derivatives instruments, new index design, and new business methods to address these issues properly. In addition, treating real estate properties simply as equities which typically have uncertain future variable yields in the form of dividends are not sufficient to develop more sophisticated derivatives markets such as forwards and options. Therefore, there exists a need to innovate more suitable derivative instruments that could make it possible to treat real estate properties more like fixed coupon bonds as well.

One problem with the exchange-based contracts are that they are more suitable for speculators, investors or institutional middlemen such as inter bank traders who may desire to use them for hedging in order to turn around and offer other types of more consumer friendly products in the future. These exchange-based contracts themselves are by nature very complicated to use and therefore unsuitable for the average consumers/homeowners. As for the current OTC market, the TRS and PRS are not very intuitive to most people. They are difficult to understand, even for the industry professionals. A typical trade quote for a TRS is that one party is willing to offer a counter-party the total return (composed of price return calculated based on an index during the contract period and an income stream paid usually quarterly during the same contract period) while receiving from the counterparty a quarterly floating rate such as 3-month LIBOR plus a “spread”. An example of a “spread” could be 250 basis points annually as an arbitrary example.

In the case of a PRS, there is no income component for the same contract and therefore one party will only pay a quarterly “spread” to the counter-party. Although it appears that the fixed “spread” is on a floating basis as it had evolved from and still is related to a TRS, there is ambiguity whether it could be applied to fixed rate differentials as well. No implied forwards could be derived from this “spreads” information. The trading and quoting convention is more like those of trading floaters (bonds with floating interest rates) or those in cross currency basis swaps as examples in the cross currency swap markets). For example, the following are quotes for the NCREIF index swaps in the US commercial properties market on 28 Sep. 2006:

TABLE 1
NCREIF Spread Markets, Thursday, 28 Sep 2006 08:44:41-0400

| Size | Index (2 Year Reference) | Bid/Offer(*) |
|---|---|---|
| 25 mm × 25 mm | NPI Capital Value Return | 15.0/40.0 |
| 10 mm × 10 mm | Industrial vs. Retail Total Return | 0.0/30.0 |
| 20 mm × 10 mm | Office vs. Retail Total Return | 60.0/90.0 |
| 10 mm × 10 mm | Office vs. Industrial Total Return | 30.0/60.0 |
| 10 mm × 10 mm | Apartment vs. Retail Total Return | 40.0/70.0 |
| 10 mm × 10 mm | Apartment vs. Industrial Total Return | 10.0/40.0 |

| Size | Index (2 Year Reference) | Bid/Offer(**) |
|---|---|---|
| 25 mm × 25 mm | NPI Total Return | L + 250/L + 350 |
| Size | Index (3 Year Reference) | Bid/Offer(**) |
| 25 mm × 25 mm | NPI Total Return | L + 200/L + 300 |

| Size | Index (1 Year Reference) | Bid/Offer(**) |
|---|---|---|
| 10 mm × 0 mm | Office Total Return | L + 350/NA |

(*)Stated in bps/quarter
(**)Stated in bps/year; L is 3-month Libor
All capital value & property type swap trades will either settle forward or use the calculated spread feature as described in the presentation.
All Total Return Trades will start January 2007.
No Upfront Fee to enter trade.

As explained above the concepts and conventions may have derived from other esoteric institutional derivatives market such as the equity swaps market. As the equity market may be more dominated by sophisticated institutional investors, these investors may not have that much trouble with it; however, when TRS and PRS are borrowed and applied to the property markets they do not offer a good fit because the bulk of the properties are still in the hands of the unsophisticated home-owners and real-estate investors who are typically not familiar with the derivatives market. As could be easily understood that there is no way anyone can approach a 70 year old home owner to ask him to do a TRS or PRS trade quoted above in order for him to manage his home equity. Similarly it will be equally challenging to convince the same homeowner to open a margin account to trade futures in order to protect his home property value. Both the existing OTC and exchange-based contracts are way too complicated to be products for the consumers.

Even for institutional use, the current practices do not offer proper hedging correlations for hedgers as the indices they use are too broad. As a result, these markets will remain small and illiquid, and only have participation by the people who are involved in this esoteric futures industry or the current institutional OTC swaps markets. Therefore, there exists a need to develop some new improved ways to do business in the OTC market and provide related downstream consumer oriented financial products to help homeowners and the average commercial property owners to hedge their property value. At the same time, there exists a need to allow investors much better liquid, convenient, and precise ways to express their investment views in the property market. Therefore there exists a need for more user-friendly consumer financial products which will be easier to understand and use while keeping the same economic benefits of a derivative instrument.

In addition, TRS and PRS themselves from a professional and technical standpoint are very basic swapping instruments to exchange the return on one asset with a variable future yield to the return of another asset also with variable future yield. TRS and PRS do not offer many hedging functions traditionally offered by derivatives on many other asset classes, such as forwards and options. The economic functions they provide are simply synthetic spot trading, spot hedging or asset re-allocation, even with a forward starting date. Therefore there exists a need for newer trading instruments that will provide the true hedging functions of forwards and options for real estate. To use an analogy in foreign exchange (FX) trading, TRS and PRS are like spot trading or spot hedging: spot trading or hedging are ineffective to a corporate hedger or institutional investors who have hedging needs. They need over-the-counter FX forward contracts and FX options contracts to do so. Therefore, there exists a need to develop the true forwards and options equivalents in the property derivatives market. In addition, instead of simply talking about them as wish list items, there exists a need to invent a systematic methodology to create the “no arbitrage” pricing for both the forwards and options contracts that could provide economic value and convenience for the hedgers as well as the internal risk management capabilities for the financial institutions who act as middlemen and product providers.

In summary, it would be desirable to provide a bridge between the esoteric institutional derivatives world and the vast homeowner's consumer finance market. It would also be desirable to accelerate the evolutionary process for the property derivatives market by introducing prudent business methods for conducting forwards and options concepts and equivalent instruments to the market.

### SUMMARY OF THE INVENTION

In accordance with the principles of the present invention, real estate derivative financial products, index design, trading methods, and supporting computer systems are provided for property owners and investors to temporarily swap their respective economic interests in owning/disowning an underlying property for a certain period of time, directly or through some middlemen. Therefore, in addition to the traditional ways of either buying/selling or renting property, the property owner could consider a third new way of dealing with a property. The present invention provides a very straightforward way to enable property owners to protect the gains or prevent further losses in their property equity value. On another hand, the present invention also allows investors to establish an exposure in a potential property equity appreciation or depreciation in a particular neighborhood.

### BRIEF DESCRIPTION OF THE DRAWING

The foregoing aspects and many of the advantages of the present invention will be more readily appreciated as the same becomes better understood by reference to the following detailed description, when taken in conjunction with the accompanying drawings, wherein:

FIG. 1 is a schematic representation of an example real estate index derivative product in accordance with the principles of the present invention.

FIGS. 2a and 2b are schematic representations of example real estate index options in accordance with the principles of the present invention.

FIG. 3 is a schematic representation of example property or home equity locking and future value choice mortgage products in accordance with the principles of the present invention.

FIG. 4 is a schematic representation of an example property index linked note or real estate index linked deposit in accordance with the principles of the present invention.

FIG. 5 shows a non-limiting example of a network hardware infrastructure hardware infrastructure that can be used to run the system of the present invention.

FIG. 6 shows a flow chart of a non-limiting example a method in accordance with the principles of the present invention.

FIG. 7 is a schematic representation of an exemplary industry structure that incorporates the real estate index derivative products of the present invention.

### DETAILED DESCRIPTION OF THE INVENTION

While an exemplary embodiment of the invention has been illustrated and described, it will be appreciated that various changes can be made therein without departing from the spirit and scope of the invention.

The following description describes several aspects of the present invention. For ease of description, these various aspects have been titled with the following nomenclature, some of which incorporate the inventor's trademark names: “SwapRent^{SM}”, “REIO”, “OTC Options and Forwards”, “REIDeX.com”, “SwapRent.com”, “PELM”, “HELM”, “FVCM”, “PILN”, “REILD”, “an Index Construction”, and “Example Hardware and Methodology”. It should be understood that the use of these terms in no way limits or narrows the scope of the present invention.

In accordance with the principles of the present invention, novel methods and financial products are provided that are neither a purchase and sale nor a renting of real estate property. The present invention provides a straightforward way for property owners to protect gains in their property equity value, thereby avoiding price fluctuations of the property for a short or long period of time. In contrast to prior-art real estate derivative financial instruments, in the present invention the property owners do not need advanced knowledge or education in derivatives or other sophisticated institutional capital markets instruments. The present invention comprises consumer-oriented methods and financial products that can be offered directly to property owners/customers. At the same time, the present invention also enables investors to establish exposure in potential real estate equity appreciation or depreciation in a particular neighborhood by creating synthetic long positions in real estate without requiring the real cash traditionally required to do so. In the present invention, property owners and investors could be enabled to make transactions with each other or through a middleman or several layers of middlemen, and a marketplace could be created for these new types of transactions.

### SwapRent^{SM}

In accordance with the principles of the present invention, a synthetic “rent” or more technically “yield” is created to represent a proxy for property owners to economically switch from owning a property to “renting” a property instead without the attendant costs of a sale and lease-back transaction. When used herein, the quoted term “rent” refers to this synthetic “rent” or “yield”. Property owners can make a payment for “renting” their own property for a certain period of time and therefore achieve the objective of not incurring a potential loss or gain in their property value in that same time period, while continuing the existing legal ownership. In one embodiment, financial institutions such as banks, mortgage lenders or home equity lenders can be engaged to either act as middlemen between the property owners and investors or simply as guarantors of the credit exposures associated with such transactions. The financial institutions could in turn manage the credit exposure for themselves by using many existing banking products such as collaterals, liens, and mortgages in a home equity line of credit (HELOC). The methods and financial products of the present invention incorporate the traditional superior advantages of derivative instruments over their cash equivalents, but financial institutions will be able to offer them to the unsophisticated property owners without having to call them derivative instruments, especially in the form of new property value linked mortgage products with these real estate index derivative instruments built in. This advantageously puts the financial institution on familiar footing: financial institutions have been marketing interest rate derivatives to property owners in the past in the form of mortgages for decades; when financial institutions offer long-term fixed-rate mortgage loans with prepayment options to property owners, they are in effect offering fixed-rate loans together with interest-rate derivatives.

The real estate index derivative products of the present invention are designed to hedge or invest in a parallel market to the underlying real estate market. The underlying market is called a “cash market” for real estate properties. In accordance with the present invention, investors can utilize real estate index derivative products of the present invention to establish a synthetic long position. But if hedgers are not brought into the market, there will not be volume and liquidity. There are various trading and hedging strategies users can employ which are established standard practices to many other over-the-counter (OTC) derivatives markets such as for example the equity market, interest rate market, energy market, and other commodities. For example, hedgers who already own an underlying real estate property can utilize a real estate index derivative product of the present invention of equal notional amount in order to hedge the price risk of their properties.

Supply and demand will drive the market for real estate index derivative products of the present invention in a similar way supply and demand drive the underlying cash market for real estate properties. The two markets (real estate index derivative products and underlying cash market) are running in parallel, but are linked by a particular relationship in order to prevent risk-less profitable arbitrage opportunities. At a given point in time, the market may steer towards more selling (paying the synthetic “rent” like a quasi “tenant”) or more buying (receiving the synthetic “rent” like a quasi “landlord”) depending on the particular market sentiments, but all-in-all the market will establish an equilibrium point to prevent risk-less profitable arbitrage opportunities.

In a typical transaction involving real estate index derivative products of the present invention, the property owner will pay a synthetic “rent” of the real estate index derivative products while an investor will receive the synthetic “rent” of the real estate index derivative products so that price fluctuations based on an index will be transferred to the investor. The real estate index derivative products of the present invention that are traded will reflect more than just a conventional rent concept; the synthetic “rent” of the real estate index derivative products of the present invention will incorporate the aggregation of yield derived from the actual rents (if any), risk premium of holding property equity, transaction costs, tax considerations, and overall supply and demand sentiments at a particular point in time. Therefore, this traded synthetic “rent” will have no direct, straightforward relationship with the actual rent yield that the property owner may have been able to collect. The difference could be like what a coupon (actual rent) is to a fixed rate bond of certain maturity versus what the current term structure yield level (synthetic rent) is to similar bonds of similar maturities traded in the capital markets. In return, the property owner/hedger will receive a funding cost that for example can be expressed as a floating rate such as 3-month or 6-month London Inter-Bank Offered Rate (LIBOR) calculated based on London fixing at the settlement dates or a fixed rate such as the swap rate from the interest rate swap market for a maturity that matches the duration of the real estate index derivatives products of the present invention. An investor who takes the opposite position will receive the price changes expressed through the settlement of the difference in property value during the holding period in addition to receiving the synthetic “rent” of the real estate index derivative products of the present invention.

An arbitrage opportunity may exist if the synthetic “rents” are priced out of line and, therefore, market equilibrium could be achieved as explained above. For example, if by paying the synthetic “rent” based on the index of a particular like kind property neighborhood for the notional amount of a particular buy-to-let condo that a property owner actually owns in that neighborhood, an almost no-risk arbitrage profit could be made by simply physically renting out the buy-to-let condo and collecting a real rent, if the real rent is much higher than the synthetic “rent”. Then many similar transactions will keep happening until the synthetic “rent” rises to a certain level so that, after considering all the transactional costs involved, no such risk-less arbitrage opportunities may exist any more. The existence of arbitrage opportunities that enhance market liquidity will be a key success factor to building any new derivatives market.

In addition to the real estate index derivative products, in accordance with the principles of the present invention related derivative instruments can also be provided as explained in detail below. The real estate index derivative products and the related derivative instruments of the present invention will increase liquidity as they offer a much closer hedge for property owners. In addition, the real estate index derivative products and the related derivative instruments of the present invention will increase liquidity as they create a much closer proxy for owning a real underlying property for the potential real estate investors than other methodologies proposed currently by other academics and practitioners. Through offering trading liquidity, the market for real estate index derivative products and related derivative instruments of the present invention will make it possible for traditional institutional investors such as corporate pension funds and insurance companies for example to treat property equity as a separate and distinct investment asset class, especially in the case of residential real estate properties which has never been properly treated as such in the past.

In one embodiment, real estate index derivative products of the present invention can be created based on real estate indices, as described in detail below. The indicated bids and offers could be matched and cleared based on an exchange format; alternatively, the indicated bids and offers could be just an indication of interest for both buyer and seller in a brokerage format in order for them to privately negotiate the final price and settlement details. In one example, these details can be based on an ISDA-like documentation convention. The concept) after the marking-to-market process, the account holders can be requested to top up their collateral to a level which will be enough to cushion the volatilities of the next mark-to-market exercise. A property owner's credit risk exposure could be better handled through new mortgage products of the present invention described in detail below. On the other hand, an investor's credit risk exposure could be better handled through new structured investment products of the present inventions described in detail below.

In order to tap into the bulk of the property owner's market, the success lies in the elegance of the product design. The pricing of the real estate index derivative products of the present invention will be determined by the market itself to prevent risk-less arbitrage opportunities as explained above. The synthetic fixed or floating “rent” component of the real estate index derivative products of the present invention can be conveniently expressed as an annualized percentage yield number to represent income similar to how 3-month LIBOR or a fixed two-year swap rate is expressed as an annualized percentage interest rate number to represent a financing cost. For any real estate properties, within a particular holding period (with +/−signs from an investor's perspective),

Total Returns=IBCR+Synthetic “Rent”−MFC

or from a property owner's perspective,

Total Returns=−IBCR−Synthetic “Rent”+MFC

where IBCR is the index based capital returns component of the present invention and MFC is the mortgage funding cost. The synthetic “rent” represents the yield component of the present invention and can be expressed or referred to as a brand name such as for example as the non-limiting “SwapRents^{SM}” of the present invention. The synthetic “rent” could be quoted in fixed yield format for the entire product maturity or it could be quoted as floating yield format for a particular floating period such as a 3-month reset, a 6-month reset or an annual reset within the entire product maturity. For practical purpose a fixed “rent” market will provide important information for the further development of the implied forwards and options markets.

The mortgage funding cost could be expressed either in floating interest rates or fixed interest rates for any particular currency. Floating interest rates and fixed interest rates are interchangeable through the interest rate swap market in that particular currency. As the synthetic “rents” of the present invention will be able to derive the crucial synthetic fixed “rent” information of different maturities of groups of properties represented by a particular neighborhood or region (like the yield curve term structure concept of interest rate products), the synthetic floating “rent” information could also be derived in a similar way by a slight modification of simply specifying the synthetic “rents” to be traded to express a particular floating period, say 3-month, 6-month or annual periods. The synthetic floating “rents” thus created in the present invention will be able to connect to the existing Total Return Swaps (TRS) market conventions should a TRS market be developed on these lower level, granular property indices as well.

Since the present invention will be able to create both the synthetic fixed “rents” of different product maturities (term structure) and the related synthetic floating “rent” of different floating periods within the different product maturities of the groups of the properties of a neighborhood or region, a fixed verses floating swap market of synthetic “rents” itself could be further developed through traded information from these synthetic fixed and floating “rent” markets of the present invention.

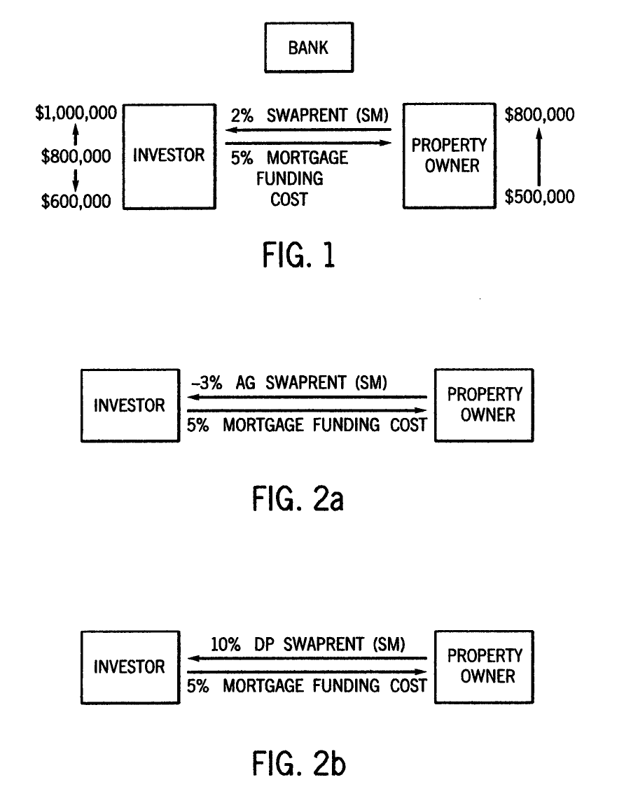

Referring to FIG. 1, among many other variations in one embodiment a typical example might involve a property owner who bought a house three years ago for $500,000. The current market value of that house is about $800,000. The property owner could utilize the present invention in which the property owner will pay an investor a synthetic “rent”, say annually 2% of the house value, for the next two years while the property owner will be protected from the ups and downs of the house value for that two years period. The investor will receive the “rent” payment and pay the property owner a mortgage funding cost based on, as an example, a floating rate such as the 3-month or 6-month London Inter-Bank Offered Rate (LIBOR) or more often than not, a fixed rate. An example could be a fixed annual rate of 5% for the two-year product period.

In this example, the actual payments of the synthetic “rent” of the real estate index derivative product of the present invention that is expressed as an annualized percentage of 2% (the same way as the fixed mortgage funding cost of 5%) could be determined by multiplying the house value and prorating to arrive at a weekly, bi-weekly, monthly or quarterly actual payment amounts (in the same way as the funding cost). The property owner's payments and the mortgage funding cost payments could be offset and be netted against each other, so only a netted payment is to be paid either to the property owners or the investors each week, each bi-weekly period, each month or each quarter, depending on the local market preferences.

Two years later at the end of period the house value could either be $1,000,000 or $600,000, for example. The starting and ending values of the house could be determined based on a preset mutual agreement such as for example either through real appraised values or as weighted average or median price per square foot in a particular neighborhood using the index described more in detail below. If the property value has risen to $1,000,000 at the end of period, the gain of $200,000 will belong to the investor and the property owner will have to cash settle it by for example borrowing further from, as a non-limiting example the HELOC, on the house and paying the amount to the investor. The financial institution could also either simply increase the original mortgage amount by the mortgage products of the present inventions as explained below or simply view it as a further drawdown of the property owner's HELOC if one has already been set up already. If the house value decreased to $600,000 at the end of period, then the property owner will be paid by the investor for the $200,000 difference ($800,000 minus $600,000) and therefore achieve the objective of property equity value protection. The property owner could enter into another new real estate derivative financial product of the present invention for another say 3 or 5 year period with another investor or alternatively the property owner could decide to sit tight on it for the time being without further any further hedging activities. The financial institution may have asked the investor along the way to put up more collateral so that to ensure by the settlement date of the real estate derivative financial product of the present invention the investor will have the necessary cash to payout to the property owner.

The predictive evolution of the tax treatment for the tax authority in the future in this example is as follows (subject to future tax ruling): if the property value has risen to $1,000,000 at the end of period, then the property owner's cost basis for tax purpose could be increased to $700,000 (instead of the original cost basis of $500,000) after the cash settlement payment at the end of the product period. If the house value drops down to $600,000 at the end of the period, then the property owner's cost basis for tax purpose could be decreased down to $300,000 and, the property owner would continue to own the house with a then current market value of $600,000.

The financial institution may have asked the investor along the way to put up more collateral so that to ensure by the settlement date the investor will have the necessary cash to pay out to the property owner should the house value drop. This practice is analogous to that of a share margin trading account or a foreign exchange margin trading account that has been widely accepted by investors. The synthetic “rent” rates utilized in the present invention, expressed and quoted for example as an annual percentage number per each neighborhood such as ZIP code or postal code neighborhoods, towns or cities throughout the country, can be quoted and traded on an Internet portal site such as SwapRent.com and REIDeX.com. described below

### REIO—Real Estate Index Option

In accordance with the principles of the present invention, variations of different levels of trading of the synthetic “rents” of the financial products of the present invention could provide the optionality in which the end-user property owners may be interested. Solely for the purposes of description and not of limitation, these are contrasted from so-called “first generation” real estate derivative financial products of the present invention as described above. The implied forward value of the properties derived from the prices of the synthetic fixed “rents” traded in the marketplace for “first generation” financial products of the present invention will provide pricing information and be incorporated into option pricing models. Taken a few steps further, the options market itself could be developed from an extension of these same synthetic fixed or floating “rent” markets without the need to resort to any complicated option pricing models.

The conventional understanding of a call and put option could be expressed in levels of trading of real estate derivative financial products of the present invention (all in percentage of the notional amount, +/−signs are from the property owner's perspective) as follows:

Short Call Premium=(−AG “Rent”+MFC)

Long Put Premium=(−DP “Rent”+MFC)

substituting:

$$\begin{matrix}- GSR “ Rent ” + MFC = Simultaneously Short Call and Long Put \\ = ( - AG “ Rent ” + MFC ) + ( - DP “ Rent ” + MFC ) \\ = - DP “ Rent ” - AG “ Rent ” + 2 * MFC\end{matrix}$$

therefore:

−GSR “Rent”=−DP “Rent”−AG “Rent”+MFC

or from an investor's perspective:

GSR “Rent”=DP “Rent”+AG “Rent”−MFC,

where GSR is a “first generation” real estate derivative financial product of the present invention, AG is a short “appreciation give-up” financial product of the present invention, DP is a long “depreciation protection” financial product of the present invention, with all nomenclature referred to from the property owner's perspective, and, again, MFC is the mortgage funding cost. This is comparable to the put-call parity of the conventional understanding of the option market.

In plain language, from the property owner's perspective, this means that a neutralizing short hedging “first generation” real estate derivative financial product of the present invention represents a simultaneous 100% give-up of the future appreciation and a simultaneous 100% of downside protection. The two legs of the long depreciation protection financial product of the present invention and the short appreciation give-up financial product of the present invention combined together make a financial product of the present invention a short position against the original long property; hence, the fully “hedge” concept is realized. But a financial product of the present invention does not have to be traded with both transaction legs at the same time; hence, the optionality concept could be realized.

Since the mortgage finding cost either expressed in fixed interest rate or floating interest rate is a given fixed parameter at a given point in time, the trading level of a synthetic “rent” of a short appreciation give-up financial product or a long depreciation protection financial product itself will determine the value of the call or put option premium based on the same notional amount of the property value expressed as a percentage of the property value. To help further facilitate an understanding, how the trading levels of the synthetic “rents” of “first generation” real estate derivative financial products of the present invention will usually behave is based on how particular market sentiments is perceived. They would typically be driven by the market supply/demand and expectation factors. For a simple numerical example, assume the mortgage funding cost is at 5% (fixed interest rate as an example) and the synthetic “rent” of the “first generation” real estate derivative financial product of the present invention is trading at 2% (in fixed yield format as an example) of the property value. Based on an $800,000 value of property, the property owner who has entered into a financial product of the present invention for two years will receive $40,000 (5% of $800,000) every year (perhaps divided in monthly cash flow exchange) from the investor and will pay $16,000 (2% of $800,000) to the investor. The property owner will have a positive cash in-flow of $24,000 every year (say, $2,000 per month).

In a rising market where most people expect the property value will increase in the near future, the trading level of the synthetic “rent” of a real estate derivative financial product of the present invention will tend to be traded at a relatively low level and usually below the mortgage funding cost level, say 2%. This situation can be referred to as a “positive carry” for the property owners because the netted monthly cash flow exchange will be a net credit to the property owners as a cash in-flow as demonstrated in the example above. Conversely, this situation can be referred to as a “negative carry” for the investors. The synthetic “rent” could even be trading at a negative level if the market is really driven by a bullish euphoria. That could mean that the property owners will be paid so much by the investors to house sit for the investors so that the property owners would be willing to give up the very likely, though still uncertain, future upside appreciation potential to the investors for a certain period of time.

On the other hand, in a declining market the trading level of the synthetic “rent” of a real estate derivative financial product of the present invention will be high and usually will be higher than the mortgage funding cost level, say 7%. In this case the annual payment that the property owner will have to pay would be $56,000 to the investor and it will result in a netted annual $16,000 cash out-flow for the property owner. This situation can be referred to as a “negative carry” for the property owners and “positive carry” for the investors. This could mean the property owners will have to pay up to other investors in order to pass on the very high and undesirable depreciation risk to the investors given the very strong bearish market expectation.

Whether it is trading at 2% or 7%, when the mortgage funding cost is at 5% a “first generation” real estate derivative financial product of the present invention will demand that both the potential upside appreciation is given up from the property owner to the investor and the potential downside depreciation is at the same time passed on from the property owner to the investor as well. Paying a synthetic “rent” of an appreciation give-up financial product of the present invention “alone” on another hand will only demand that the property owner give up the potential upside appreciation to the investor while maintaining the downside depreciation risk. If that is the case, the trading level of the synthetic “rent” of an appreciation give-up financial product of the present invention could understandably be traded at a relatively even lower level, say 1% or 0%, and could even be trading at a negative level, say −3%.

Referring to FIG. 2a, using a −3% example, we can see that in this case the property owner will receive a netted 8% (=5%−(−3%)) annual cash in-flow (maybe paid monthly) from the investor in order to give up the uncertain future potential appreciation to the investor. The property owner's existing real mortgage payment could be at say 6.5% (5% of 2-year interest rate swap rate plus a credit spread of 1.5% for example). Adding another assumed annual 1% of property tax the property owner's carrying cost for owning the property would be 7.5%. This means the property owner will be paid a net 0.5% (=8%−7.5%) while retaining the legal ownership of the property for the property owner to consider well enough compensated for giving up some uncertain future appreciation that may or may not even be realized at all. In the mean time the property owner gets to use the property “rent-free”.

Continuing the same example above, it will come up to $333.33 (=0.5%*$800,000/12) of a monthly check of income, after the entire mortgage and property tax bill has already been paid for by the investor, for the property owner to manage (property sit) the property for the investor “rent-free”. Although the future uncertain appreciation potential has been handed over to the investor that may or may not even be realized, the property owner is also accruing equity while the mortgage principal is being paid down by the money received from the investor. If this is still not good enough, when the synthetic “rent” of an appreciation give-up financial product of the present invention is trading at −5% it may start generating some real interests as the monthly income check jumps up to $1,666.66. When this happens the property owner will not only have free housing, but also free accumulation of property equity and a monthly check of $1,666.66 for spending money. All he will give up for getting all this is some uncertain future upside appreciation potential that may or may not even be realized for the short product period. If for some reason he changed his mind after committing to this transaction, he could simply unwind it any time by paying a bid/offer spread assuming the market parameters have not moved. Whether the synthetic “rent” of the appreciation give-up financial product of the present invention will be traded at −3% as in the example, at say −5% (high appreciation expectation) or at say 0% or 1% (low appreciation expectation) will be determined by free market forces which are usually driven by supply/demand, future expectation, and the existence of arbitrage opportunities based on these yield differentials.

A preferred application of the appreciation give-up financial products of the present invention is that it could be an improvement or replacement for the current Shared Equity Mortgage (SEM), Shared Appreciation Mortgage (SAM), and the Reverse Mortgage (RM) or the Home Equity Conversion Mortgage (HECM) markets. It should be recognized that in the U.K., these carry different names such as Home Reversion Scheme, Life Time Mortgages and Home Income Plan, etc. The advantages offered by appreciation give-up financial products of the present invention are those of the usual typical advantages of derivative instruments over their cash instrument equivalents, for example, their shorter term flexibility and the reversible nature of the transaction in addition to the savings on transaction cost as well as the avoidance of legal title transfer and its associated tax events. Again the 8% (=5%−(−3%)) annual net cash in-flow paid monthly to the property owner could be considered the short call option premium.

The opposite could be said about the depreciation protection financial products of the present invention in that the property owner will only be awarded the potential downside protection from the investor while maintaining the unlimited upside appreciation potential. This is a desirable economic feature to have and therefore the property owner will understandably pay up for gaining this advantage. Referring to FIG. 2b, in this case the trading level of the synthetic “rent” of the depreciation protection financial products of the present invention could understandably be traded at a relatively high level, say 10%. Using the 10% as an example, the property owner will receive a netted −5% (=5%−10%) of the property value. This can be represented as an annual (maybe paid out monthly) cash out-flow to the investor in order to get the future depreciation protection from the investor. This −5% of property value cash out-flow could be considered the cost of owning a long put option premium for the property owner.

Using the same previous property owner's total existing carrying cost example for owning the property as 7.5%, this means the property owner will be paying a net of 12.5% (=5%+7.5%) for retaining the property without any worry of potential downside depreciation risk while occupying the property “rent-free” and accumulating home equity for free. Again, the investor will have to be satisfied that the property owner has compensated him/her well enough for assuming the uncertain future depreciation loss potential that may or may not even be realized. Whether the synthetic “rent” of the depreciation protection financial products of the present invention will be traded at 10% as in the example, at say 12% (high depreciation expectation) or at say 5% or 4% (low depreciation expectation) will again be determined by the free market forces. As previously explained above, there exists a constraint that (from the property owner's perspective)

−GSR “Rent”=−DP “Rent”−AG “Rent”+MFC

When the numbers from the examples above are plugged in (−2%=−10%−(−3%)+5%) the relationship holds true. This is again the put-call parity of the present invention.

A preferred application of the depreciation protection financial products of the present invention is for those risk-averse conservative and wealthy property owners who will treat their property not just as a shelter but also as a financial asset that they own and therefore may be more willing to pay to buy protection against the potential financial loss. They are usually high income-earners who are able, and therefore more likely interested in doing so. As will be made clear by detailed explanations below, this cost of acquiring the downside protection insurance could easily be financed through some simple combination strategies where both appreciation give-up financial products of the present invention and downside protection financial products of the present invention are employed simultaneously again.

Used alone separately, either the appreciation give-up financial products or the depreciation protection financial products of the present invention will provide economic value to the property owners by providing either the 100% upside give-up in order to get present cash in-flow as compensation or the 100% downside protection if they want to pay for a peace of mind. On the other hand, investors on the other side of the transaction get to buy a future appreciation opportunity of the property in which they are interested through the same appreciation give-up instrument or they could get some present cash in-flows in order to offer a protection to the property owner through underwriting the potential downside risks that may or may not even be realized in the future. These economic benefits are well known in the use of options on many other assets classes.

Thus, it is seen that the “first generation” financial products, appreciation give-up financial products, and depreciation protection financial products of the present invention facilitate economic benefits to the property owners and investors for their property transactions for the first time. The value they provide does not only reside in when they are used alone; they provide much more versatility when utilized in various combined formats as in many option “strategies”. Some non-limiting examples follow.

In a combination, the appreciation give-up notional amount and the depreciation protection notional amount do not have to be the same. For example, if the property value is worth $1,000,000, the notional amount for an appreciation give-up financial product could be for $400,000 and the notional amount for a depreciation protection financial product could be for $800,000 or vice versa. Other combinations are also possible. In a combination, the appreciation give-up starting/maturity date and the depreciation protection starting/maturity date do not have to be the same. For example, the appreciation give-up financial product may start immediately and end in 3 years and the depreciation protection financial product could start in one year and end in 5 years or vice versa. Again, other combinations are also possible.

In a combination, the appreciation give-up starting value (strike price) and the depreciation protection starting value (strike price) do not have to be the same. For example, the appreciation give-up financial product could start giving up the value from 25% above (or 10% below) the current or future starting value and the depreciation protection financial product could start protecting only from 20% below (or 5% above) the current or future starting value. Other combinations are also possible. These property values could be determined by an index such as described below, for example. Due to the various strategies of combinations of appreciation give-up financial products and depreciation protection financial products based on the views of the property owners (and the investors), there may be netted upfront cash payouts/payments or monthly cash inflows/outflows to and from the property owners (and the investors).

### OTC Options and Forwards

In accordance with the principles of the present invention, important “no arbitrage” pricing information of over-the-counter forwards and options trading products could be provided by the “first generation” real estate derivative financial products as well as appreciation give-up financial products and depreciation protection financial products. Theoretically speaking, the trading of the synthetic fixed “rents” of a “first generation” real estate derivative financial product of the present invention provides the implied forward value for the property. This could be derived from the interest rate parity. In a simple example, the interest rate parity dictates the relationship between the forward price (F) of t days in the future, two fixed yields (Ya and Yb) and a spot price (S) in the following formula: F/S=(1+Ya*(t/365))/(1+Yb*(t/365)). So with the fixed synthetic “rent” and the fixed-rate finding cost for a given product period as well as the current price of the property, the fair value implied forward price of the property could easily be derived.

In addition, having the information of the appreciation give-up financial product and depreciation protection financial product synthetic “rents” trading levels, an effective options market could be actually started. In addition, the vital statistics of implied option volatilities could be further derived from some simple conventional option pricing models, assuming they are applicable to the property as an asset class, and subsequently applied to more sophisticated ways of developing more exotic kinds of option-oriented property derivatives. As a result, trading forwards and options will not just remain wish list items to talk about for the property markets or blind punting games with no reasonable ways to figure out what the fair value pricing is. There will exist arbitrage opportunities constrained by the interest rate party or any simple option pricing models that may be able to apply to the property as an asset class. The financial institutions who provide such products to the end users will also be able to manage their own internal market making and trading risks better by having these fair value pricing methodologies and the necessary means to mark-to-market their positions.

### REIDeX.com (Real Estate Index Derivatives eXchange)

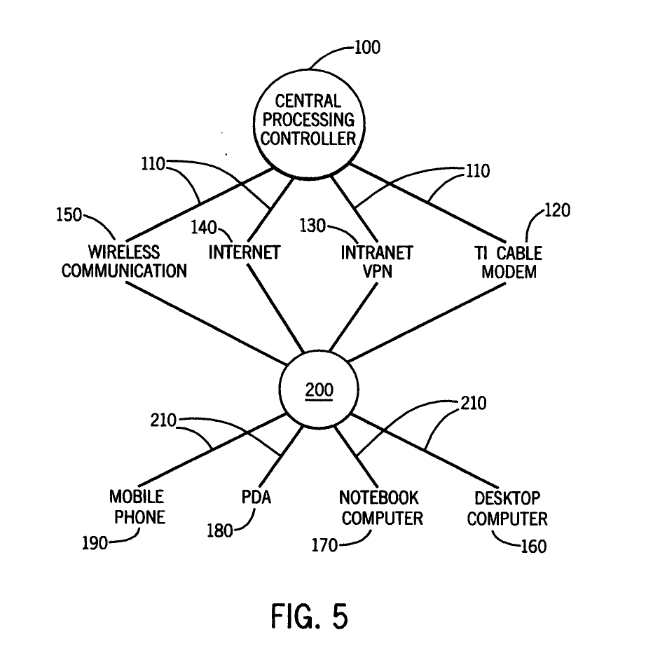

In accordance with the principles of the present invention, a trading forum can be provided for the “first generation” real estate derivative financial products, the appreciation give-up financial products, and the depreciation protection financial products of the present invention as well as other generic swaps, forwards, options, and swaptions contracts on real estate indices. In one embodiment of such a trading forum, an Internet portal site serves as an on-line exchange that offers price indications and execution capabilities for buyers and sellers of the real estate index derivative products of the present invention. In one embodiment, the trading forum can be run on the network hardware infrastructure example described in conjunction with FIG. 5, below.

Tables 2-5 set forth non-limiting examples of such an on-line exchange that offers price indications for buyers and sellers of the real estate index derivative products of the present invention. Table 2 sets forth a non-limiting example listing for “standard” real estate index derivative products of the present invention for Los Angles, Calif. The listing includes the designated area, an index settlement (in U.S. Dollars) for the area, and the bid/offer for various terms of the “first generation” real estate index derivative financial products.

TABLE 2
Los Angles

| | Index | | | | | | | | |
|---|---|---|---|---|---|---|---|---|---|
| | Settlmnt | 1 YR | 2 YR | 3 YR | . . . | 5 YR | . . . | 10 YR | . . . |
| Neighborhood 1 | 350 | 2.5/2.3 | 2.5/2.3 | 2.6/2.4 | | 2.5/2.2 | | 2.4/2.2 | |
| Neighborhood 2 | 325 | 2.5/2.3 | 2.6/2.3 | 2.5/2.3 | | 2.3/2.1 | | 2.6/2.3 | |
| Neighborhood 3 | 330 | 2.5/2.3 | 2.5/2.3 | 2.6/2.4 | | 2.4/2.2 | | 2.5/2.3 | |
| Neighborhood 4 | 250 | 2.0/1.8 | 2.2/2.0 | 2.3/2.0 | | 2.3/2.0 | | 2.4/2.1 | |
| Neighborhood 5 | 200 | 1.9/1.6 | 1.9/1.7 | 2.1/1.9 | | 2.2/2.0 | | 2.3/2.0 | |
| . . . | . . . | | | | | | | . . . | |
| Neighborhood 26 | 650 | 2.5/2.3 | 2.7/2.5 | 2.8/2.6 | | 2.6/2.3 | | 2.3/2.0 | |
| Neighborhood 27 | 725 | 2.7/2.5 | 2.8/2.6 | 2.8/2.5 | | 3.2/3.0 | | 3.3/2.9 | |
| . . . | . . . | | | | | | | . . . | |
| Neighborhood 38 | 1500 | 3.3/3.1 | 3.3/3.2 | 3.5/3.2 | | 3.7/3.5 | | 3.8/3.6 | |
| Neighborhood 39 | 1750 | 3.5/3.3 | 3.6/3.4 | 3.7/3.5 | | 3.5/3.2 | | 4.2/3.9 | |

Table 3 sets forth a non-limiting example listing for depreciation protection financial products of the present invention for Hong Kong. Again, the listing includes the designated area, an index settlement (in Hong Kong Dollars) for the area, and the bid/offer for various terms of the depreciation protection financial products.

TABLE 3
Hong Kong

| | Index | | | | | | | | |
|---|---|---|---|---|---|---|---|---|---|
| | Settlmnt | 1 YR | 2 YR | 3 YR | . . . | 5 YR | . . . | 10 YR | . . . |
| Neighborhood 1 | 3500 | 8.5/8.3 | 8.5/8.3 | 8.6/8.4 | | 8.5/8.2 | | 8.4/8.2 | |
| Neighborhood 2 | 3250 | 8.5/8.3 | 8.6/8.3 | 8.5/8.3 | | 8.3/8.1 | | 8.6/8.3 | |
| Neighborhood 3 | 3300 | 8.5/8.3 | 8.5/2.3 | 8.6/8.4 | | 8.4/8.2 | | 8.5/8.3 | |
| Neighborhood 4 | 2500 | 8.0/7.8 | 8.2/8.0 | 8.3/8.0 | | 8.3/8.0 | | 8.4/8.1 | |
| Neighborhood 5 | 2000 | 7.9/7.6 | 7.9/7.7 | 8.1/7.9 | | 8.2/8.0 | | 8.3/8.0 | |
| . . . | . . . | | | | | | | . . . | |
| Neighborhood 26 | 6500 | 8.5/8.3 | 8.7/8.5 | 8.8/8.6 | | 8.6/8.3 | | 8.3/8.0 | |
| Neighborhood 27 | 7250 | 8.7/8.5 | 8.8/8.6 | 8.8/8.5 | | 9.2/9.0 | | 9.3/8.9 | |
| . . . | . . . | | | | | | | . . . | |
| Neighborhood 38 | 15000 | 9.3/9.1 | 9.3/9.2 | 9.5/9.2 | | 9.7/9.5 | | 9.8/9.6 | |
| Neighborhood 39 | 17500 | 9.5/9.3 | 9.6/9.4 | 9.7/9.5 | | 9.5/9.2 | | 10.2/9.9 | |

Table 4 sets forth a non-limiting example listing for appreciation give-up financial products of the present invention for London. Again, the listing includes the designated area, an index settlement (in British Pounds) for the area, and the bid/offer for various terms of the appreciation give-up financial products.

TABLE 4
London

| | Index | | | | | | | | |
|---|---|---|---|---|---|---|---|---|---|
| | Settlmnt | 1 YR | 2 YR | 3 YR | . . . | 5 YR | . . . | 10 YR | . . . |
| Neighborhood 1 | 350 | −2.3/−2.5 | −2.3/−2.5 | −2.4/−2.6 | | −2.3/−2.5 | | −2.2/−2.5 | |
| Neighborhood 2 | 325 | −2.4/−2.6 | −2.5/−2.7 | −2.3/−2.5 | | −2.4/−2.6 | | −2.5/−2.7 | |
| Neighborhood 3 | 330 | −2.3/−2.5 | −2.4/−2.6 | −2.3/−2.6 | | −2.3/−2.6 | | −2.6/−2.8 | |
| Neighborhood 4 | 250 | −2.4/−2.6 | −2.3/−2.5 | −2.4/−2.7 | | −2.5/−2.7 | | −2.7/−2.9 | |
| Neighborhood 5 | 200 | −2.2/−2.5 | −2.4/−2.7 | −2.5/−2.8 | | −2.2/−2.5 | | −2.6/−2.8 | |
| . . . | . . . | | | | | | | . . . | |
| Neighborhood 26 | 650 | −3.1/−3.3 | −3.2/−3.4 | −3.5/−3.7 | | −3.3/−3.5 | | −3.2/−3.4 | |
| Neighborhood 27 | 725 | −3.3/−3.5 | −3.3/−3.5 | −3.4/−3.6 | | −3.4/−3.7 | | −3.3/−3.7 | |
| . . . | . . . | | | | | | | . . . | |
| Neighborhood 38 | 1500 | −3.3/−3.5 | −3.3/−3.5 | −3.4/−3.6 | | −3.6/−3.8 | | −3.6/−3.9 | |
| Neighborhood 39 | 1750 | −3.4/−3.6 | −3.4/−3.6 | −3.4/−3.7 | | −3.5/−3.8 | | −3.5/−3.8 | |

Table 5 sets forth a non-limiting example listing for “standard” real estate index derivative products of the present invention for commercial properties in New York. The listing includes the designated property type (apartment, hotel, industrial, office, retail, etc.), an index settlement (in U.S. Dollars) for the area, and the bid/offer for various terms of the real estate index derivative products.

TABLE 5
New York

| | Index | | | | | | | | |
|---|---|---|---|---|---|---|---|---|---|
| | Settlmnt | 1 YR | 2 YR | 3 YR | . . . | 5 YR | . . . | 10 YR | . . . |
| Apartment 1 | 350 | 2.5/2.3 | 2.5/2.3 | 2.6/2.4 | | 2.4/2.2 | | 2.4/2.2 | |
| Hotel 1 | 325 | 2.5/2.3 | 2.6/2.3 | 2.5/2.3 | | 2.3/2.1 | | 2.6/2.3 | |
| Industrial 1 | 330 | 2.5/2.3 | 2.5/2.3 | 2.6/2.4 | | 2.4/2.2 | | 2.5/2.3 | |
| Office 1 | 250 | 2.0/1.8 | 2.2/2.0 | 2.3/2.0 | | 2.3/2.0 | | 2.4/2.1 | |
| Retail 1 | 200 | 1.9/1.6 | 1.9/1.7 | 2.1/1.9 | | 2.2/2.0 | | 2.3/2.0 | |
| . . . | . . . | | | | | | | . . . | |
| Apartment 6 | 650 | 2.5/2.3 | 2.7/2.5 | 2.8/2.6 | | 2.6/2.3 | | 2.3/2.0 | |
| Hotel 6 | 725 | 2.7/2.5 | 2.8/2.6 | 2.8/2.5 | | 3.2/3.0 | | 3.3/2.9 | |
| . . . | . . . | | | | | | | . . . | |
| Office 8 | 1500 | 3.3/3.1 | 3.3/3.2 | 3.5/3.2 | | 3.7/3.5 | | 3.8/3.6 | |
| Retail 8 | 1750 | 3.5/3.3 | 3.6/3.4 | 3.7/3.5 | | 3.5/3.2 | | 4.2/3.9 | |

### SwapRent.com

While the trading forum described above will be a market place of execution of orders of the present inventions, in accordance with the principles of the present invention, a information forum can also be provided with price displays of the various last trades information of the “first generation” real estate derivative financial products, the appreciation give-up financial products, and the depreciation protection financial products of the present invention as well as other generic swaps, forwards, options, and swaptions contracts on real estate indices. In one embodiment of such an information forum, an Internet portal site serves as an on-line forum that offers last trades information of the real estate index derivative products of the present invention. In one embodiment, the information forum can be run on the network hardware infrastructure example described in conjunction with FIG. 5, below.

In a typical example of an information forum of the present invention, a Japanese investor sitting in front of his computer in his apartment in Tokyo could search the information forum of the present invention via the Internet to find a house in a tony neighborhood of suburban Paris. By checking the synthetic “rent” levels of the “first generation” financial products of the present invention, he is interested in receiving the synthetic “rent” to establish a long position to lock in the present property value and become a quasi buy-to-let landlord in a sense. In order to complete the transaction in which he is interested, he could then click on an online advertising icon of a local broker or a bank, for example, which may be put along side the web pages of the country and city he visited and in which he was interested. That advertising icon will take him to the broker's or the bank's local web site home page for him to open an account to execute the trades in which he is interested, either through electronic means or simply through the conventional ways of phone calls, emails, postal mails or faxes

The information forum of the present invention will have the special ability to attract eye balls since property owners around the world would be interested to know where the synthetic “rent” levels are currently traded in their neighborhoods for a variety of reasons. Equally, the index settlement information is also important to know in order to find out the current value of their properties in their neighborhoods. Therefore, the information forum of the present invention is suitable to be run as a stand alone ad-based Internet e-commerce business. The ad revenue will primarily come from the various middlemen such as banks, brokers and real estate agents and other information providers who are involved in the new industry created by the present inventions.

### PELM—Property Equity Locking Mortgage or HELM—Home Equity Locking Mortgage

In a further embodiment of the present invention, new mortgage products can be provided for financial institutions to offer to residential property owners or to commercial real estate property owners. The new mortgage products of the present invention will help provide flexible financing; therefore, new mortgage products of the present invention will allow property owners to lock in their equity value in the property they own for the duration of the property equity locking period established either through a derivative transaction such as a forward, an option, a total return swap (TRS), a price return swap (PRS), also called a capital appreciation swap (CAS), a real estate index derivative product of the present invention or combinations thereof.

In accordance with the mortgage products of the present invention, the property owner agrees to give up the equity gain in the property through a derivative transaction (such as a TRS, a PRS, a forward, an option or a real estate index derivative product of the present invention). The property value-gain which has to be paid out to the derivatives counterparty/investor will be reflected as an automatic increase of the borrowing amount. In effect, the borrower/property owner gives the lending financial institution a permission to let the financial institution treat the borrower's net equity in his/her property as the collateral for putting on such a property derivative transaction. The property owner will also be paid by the property value loss amount by the derivatives counterparty/investor. This amount received will also be used to automatically reduce the property owner's borrowing amount.

From the inception of the mortgage products of the present invention, either through a refinance, a new application or simply through a “switching-on” of an existing any kinds of the conventional mortgages, the borrowing amount will fluctuate automatically up and down in tandem with the asset value of the property. The frequency of marking-to-market update could be decided by the financial institutions to be either annually, quarterly, monthly, weekly or even daily given the capabilities of the index employed in the products.

The gearing ratio or leverage ratio, usually expressed as a loan-to-value (LTV) ratio in banking terms, will behave opposite to the traditional way and will never exceed 100% as what would normally happen in a traditional mortgage when there is a significant property value decline. This feature of “positive Delta” (and its associated Gamma) of LTV versus property value as compared to those of the conventional mortgages will provide financial institutions improved credit risk management features. In conventional mortgages the LTV will increase when the property value declines and therefore could be considered to possess “negative Delta”. The mortgage products of the present invention will diversify the credit risks in financial institution's entire mortgage loan portfolios. Up until now financial institutions have not been able to manage their credit risks properly in a real estate downturn or collapse. The mortgage products of the present invention will open new possibilities of options of risk management tools and strategies for financial institutions to utilize in order to remain healthy and sound. The savings from the reduced amount of regulatory risk capital required to back-up the credit risk or the lending portfolio will also be substantial in certain jurisdictions.

The new generation mortgage products of the present invention will be especially popular when the traditional real estate market is near its peak cycle. So far there have not been any other financial lending products offered to borrowers where in a declining real estate market both the borrowers and the lenders (if the lender does not act as the real estate index derivative product counterparty itself and continues to retain that particular exposure instead of laying it off to other counterparties either individually or on a portfolio basis) benefit from an actual decline or even collapse of the real estate property markets.

Since the property values risk would be hedged away through the real estate index derivatives products which are built in the mortgage products of the present invention, the borrowers will be able to demand a narrower credit spread or credit premium from the lenders and therefore make property ownership more affordable for the economy as a whole. The lenders would bear less property value risks on these new mortgage products of present invention and should be more than happy to comply. As explained above, there would not be a case that the LTV of the mortgage products of the present invention be higher than 100%. In addition, the mortgage insurance premium would be much less should one still be required by the lenders. The private and government sponsored entities that traditionally offer such mortgage insurance products will stand to benefit as well from both the mortgage products of the present inventions and the real estate derivatives financial products of the present invention, explained in detail above.

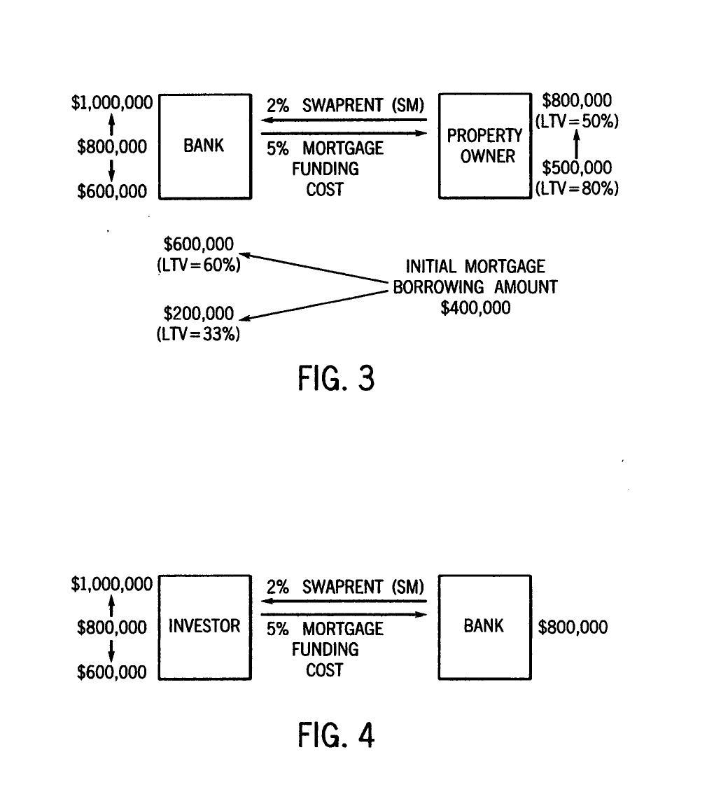

Referring to FIG. 3, among many other variations an example of a mortgage product in accordance with the principles of the present invention is described. A property owner bought a house three years ago for $500,000. The property owner may have borrowed a traditional mortgage of an amount of $400,000 (LTV=80%, Property Equity (PE)=$100,000). Assuming the current market value is now at $800,000 (LTV=50%, PE=$400,000). The property owner could get property equity protection through a derivative transaction such as a real estate index derivative product of the present invention, an OTC forward, option, TRS or a PRS. At the same time, the financial institution could arrange for a new mortgage product of the present invention to support and facilitate this property equity protection. Therefore, the derivatives transaction itself could be considered built into this new mortgage product of the present invention.

Another way of looking at it is that for every new mortgage product of present invention underwritten by the lender there will be property equity protection through a matching real estate index derivatives transaction of present invention or any other derivatives transaction such as a forward contract, an option contract, a total return swap (TRS) or a price return swap (PRS) or combinations thereof. The lending financial institution can extract out and lay off this risk in the inter-financial institution market by transacting other offsetting real estate index derivative transactions with another counterparty. Alternatively, the lending financial institution can warehouse the exposure on a portfolio basis for a period of time and lay off the netted exposures with another counter party from time-to-time upon its speculative trading and risk management decisions.

Two years later at the expiration of the real estate index derivative product, forward, option, TRS or PRS, the house value could either be $1,000,000 or $600,000, for example. The starting and ending values of the house could be determined based on a preset mutual agreement either through the real appraised value or using an index of the present invention described below. If the property value rises to $1,000,000 (LTV=40%, PE=$600,000 before considering the hedge), the gain of $200,000 will belong to the investor, and the property owner can cash settle it by an increase in the borrowing amount of a new mortgage products of the present invention on the property and pay the amount to the investor, for example. The LTV will increase to 60% and the property equity will stay unchanged at $400,000 after settling on the hedge. The property owner's cost basis for tax purpose may be increased to $700,000 (subject to future tax rulings) instead of the original cost basis of $500,000.

If the house value drops down to $600,000 (LTV=66.7%, PE=$200,000 before considering the hedge) at the end of the two-year expiration of the real estate index derivative product, forward, option, TRS or PRS, then the property owner will be paid by the investor for the $200,000 difference ($800,000 minus $600,000). Therefore, after settling the property owner will achieve the objective of property equity value of $400,000 lock-in protection. This $200,000 can be used automatically to reduce the borrowing amount per the original new mortgage products of the present invention. The LTV will decrease to 33.3% as the borrowing amount will be only $200,000 now. The property owner's cost basis will be decreased down to $300,000 (subject to future tax rulings) in this case and the property owner will continue to own the house with a then current market value of $600,000. The property owner could enter into another new real estate index derivative product, forward, option, TRS or PRS, together with a simultaneous extension of the existing new mortgage products of the present invention for another say 3 or 5 year period with the same financial institution, another financial institution or another investor directly. Alternatively the property owner could decide to sit on it for the time being without further real estate index derivative product, forward, option, TRS or PRS. In such case, the new mortgage products of the present invention could either be “switched off” and stay on and act just like a traditional mortgage again or it could be refinanced into another traditional mortgage.

In order to stabilize the monthly cash flow of mortgage payments for the borrowers, the mortgage products of the present invention could be designed in a variety of different ways. For example, the monthly mortgage payments could be selected by the property owner to change to interest only when the property asset value increases as the borrowing amount has automatically increased with the increase in property asset value. Even negative amortization could be a possible way to bring down the monthly debt service cash flow amount in this extreme case. When the property asset value declines, the borrowing amount will decrease as well and therefore the monthly payment could be activated as to include an amortization amount back again. This variation example is to make the monthly payments smoother and more stable regardless of how the asset value of the property itself fluctuates through the borrowing period.

The mortgage products of the present invention could be used either to support a property equity locking transaction such as the real estate index derivative product, forward, option, TRS or PRS, or they could be offered directly from financial institutions to the property borrowers. In the latter case, the financial institutions could manage the property equity exposure as they normally manage their other treasury or capital markets exposure in a dedicated dealing desk. In such case, the mortgage products of the present invention itself will assume the property equity protection function to the property owners. This means the property owners do not necessarily have to source the equity locking of the real estate index derivative product, forward, option, TRS or PRS on their own, but rather rely on financial institutions to offer both financing and property equity protection at the same time through the mortgage products of the present invention. In this embodiment, the real estate index derivatives transactions could be considered built into the mortgage products of present invention. All the property owners need to know is what kind of economic benefits they want by specifying directly in the mortgage products themselves that are offered by the financial institutions without any need to learn a whole new set of derivatives languages. As will be made clear below, in one embodiment as an example, the property owners can make a request to their lending banks that they would prefer to convert their existing mortgage into a new mortgage product of the present invention temporarily for a period of time, during which they would like to give up 50% of the upside appreciation potential from the current property value for the next two years in order to receive an 80% of the downside depreciation protection from the current value of the property for the next three years. All this could be done with zero upfront costs and without any subsequent cost required. After offering these mortgage products of present invention to the property owners, the financial institutions can decide to keep those property equity positions which are extracted out from these mortgages they issued to make potential speculative profit, trade them away with other institutional dealers/investors as explained above or distribute either the property exposures alone or the mortgages themselves to other retail outlets through many other capital market means such structured investment products or mortgage securitization.

The mortgage products of the present invention do not need to be offered at the same amount of the approved LTV. That means the mortgage products of the present invention could be offered to cover only part of the approved LTV amount in conjunction with another more traditional mortgage on the same property. Another way of looking at it is that the notional amount of the property equity protection part of the new mortgage of the present invention does not need to cover the entire 100% of property or the starting mortgage borrowing amount: the notional amount could be just a fraction of it. On another hand, a leveraged transaction where the notional amount of the property equity protection could be much higher than the current value of the property is also theoretically possible but may not be practical to be offered as this would entail heavy speculative exposures for both the property owners and the lending financial institutions under those jurisdictions whose regulators may be more conservative.

As previously described, the real estate index of the present invention described below provides a transparent relationship that the combined granular smaller indices could be related to one larger broad level index. This helps the design for the related derivative instruments of the present invention. For example, the retail short hedging interest exposures extracted from 200 or 300 index linked mortgage products of the present invention could be fungible or offset-able from the property value risk perspective with very little basis risk by one large long interest in a broad level index of trading real estate index derivative products of the present invention.

### FVCM—Future Value Choice Mortgage

Many different variations of option trading/investment strategies could be built within new mortgage products of the present invention for financial institutions to offer to commercial real estate property owners or residential property owners that would provide utility that does not exist in other products in the past. Property owners can choose to add various percentage amounts of the property value by an appreciation give-up feature in the new mortgage products of the present invention. In addition, property owners can choose to add various percentage amounts of the property value by a depreciation protection feature in the new mortgage products of the present invention. Of course, property owners can choose to add various percentage amounts of the property value by combinations of both appreciation give-up and depreciation protection features within new mortgage products of the present invention. In both appreciation give-up and depreciation protection mortgage products of the present invention, there can also be different starting dates and maturity dates for both as long as neither one of them will be longer than the underlying mortgage products. It could be activated repeatedly many times during the life of a mortgage product of the present invention when the first few transactions had already expired.

In both appreciation give-up and depreciation protection mortgage products of the present invention, there will be a starting property value and an ending property value to determine the value appreciation amount or value depreciation amount. The value could either be determined through an actual appraisal or through geographical neighborhood indexing such as described below. In the case of indexing, the value change can be determined from the multiplication of the property value with the index percentage change. The index method of determining property value is usually more preferred to the appraisal method as the appraisal method may cause the moral hazard effect.

In a combination, the appreciation give-up notional amount and the depreciation protection notional amount do not have to be the same. For example, if the property value is $1,000,000 the appreciation give-up mortgage product could be for $400,000 and the depreciation protection mortgage product could be for $800,000 or vice versa. Other combinations are possible.

In a combination, the appreciation give-up starting/maturity date and the depreciation protection starting/maturity date do not have to be the same. For example, the appreciation give-up mortgage product may start immediately and end in 5 years and the depreciation protection mortgage product could start in three years and end in 10 years or vice versa. Other combinations are possible.

In a combination, the appreciation give-up starting property value and the depreciation protection starting property value do not have to be the same. For example, the appreciation give-up mortgage product could start giving up the value from 25% above (or 10% below) the starting property value and the depreciation protection mortgage product could start protecting only from 20% below (or 5% above) the starting property value. Other combinations are possible.

Due to the various strategies of combinations of appreciation give-up and depreciation protection based on the views of the property owners, there may be netted upfront cash payouts/payments or monthly cash inflows/outflows to and from the property owners. For financial institutions' risk management, the underlying mortgage products can automatically monitor the property value risks and the lender's exposure by marking-to-market periodically and varying the outstanding mortgage borrowing amount against the property in order to ensure that the options or derivatives strategies employed by the property owners as agreed by the underwriters will not lead to negative equity for the property owners. Financial institutions could pass on the property value exposure derived from appreciation give-up and depreciation protection products within a mortgage product of the present invention through property derivatives trading desks to other institutional or retail traders/investors through offsetting real estate index options discussed above.

Whereas the appraisal method maybe acceptable, the small geographical neighborhood indexing approach such as postal code-based, scale-able indexing described below may be a better choice since it could avoid the moral hazard typically involved in an insurance policy. The various real estate index options passed on through the financial institutions could be traded on a centralized Internet portal exchange or simply on an OTC basis conducted through phone calls, faxes, postal mails and emails similar to the trading of real estate index derivative products since both share the same postal code-based neighborhood indices. The real estate index derivative product transactions could be combined together with the various trading/investment strategies within an appreciation give-up or depreciation protection mortgage product.

### PILN—Property Index Linked Note

### REILD—Real Estate Index Linked Deposit

In a further embodiment of the present invention, property or real estate index linked notes, bonds or deposits can be provided. These structured investment products could be created for incurring property value risk and return exposures using “first generation” real estate derivative financial products, appreciation give-up financial products, and depreciation protection financial products of the present invention or combination of part or all of the above.

Structured investment products can be created with the real estate index derivatives of present inventions, forwards, options, TRS, PRS and real estate index options discussed above as follows. First the netted differentials between the synthetic “rent” payments and the mortgage finding cost are added to the current market interest rates, yields or coupon for a note, bond or a deposit on an annual basis. Then, the price return pay-off result of the real estate index derivatives of the present inventions, forwards, options, TRS, PRS and real estate index options are linked to the principal redemption amount of the note, bond or deposit. The structured investment products of the present invention could apply to any capital market in any currency around the world.

Referring to FIG. 4, a schematic representation of an example property index linked note with a “first generation” first generation” real estate derivative financial product in accordance with the principles of the present invention is seen where:

$$Coupon = [ Depo Rate + ( 2 - 5 ) ] \%$$

$$\begin{matrix}Principal Redemption = \\ [ 1 + ( Ending Index - Starting Index ) / Starting Index ] * 100 \%\end{matrix}$$

For the sake of the simplicity of illustration, a one-year maturity of non-leveraged structured note is used in non-limiting examples below, assuming the following current market conditions in the U.S. Dollar markets:
Bid/Offer:
One year deposit rate: 4%/4% (ignoring minor spreads)
One finding cost: 5%/5% (ignoring minor spreads)
One Year Real Estate Index Derivative Product in Neighborhood ABC: 2.5%/2.0%
One Year Real Estate Index Derivative Product in Neighborhood DEF: 3.5%/3.0%
Property Price Index for Neighborhood ABC at the beginning of the year: 300
Property Price Index for Neighborhood ABC at the end of the year: 360 or 240
Property Price Index for Neighborhood DEF at the beginning of the year: 600
Property Price Index for Neighborhood DEF at the end of the year: 660

For purpose of explanation and illustration, and not limitation, the following structured notes examples could be constructed per investors' market views as follows:

Note Buyer Bullish Real Estate Index Derivative Products:
Notional Amount: Any Practical Minimum Amount
Currency: USD
Coupon: 1% (=4+(2−5))%
Principal Repayment at Maturity: 100%*[1+(X−300)/300]
One year later, if the index for Neighborhood ABC settles at 360 the principal will have a positive 20% return of profit.
One year later, if the index for Neighborhood ABC settles at 240 the principal will have a negative 20% return of loss.

Note Buyer Bearish Real Estate Index Derivative Products:
Notional Amount: Any Practical Minimum Amount
Currency: USD
Coupon: 6.5% (=4+(5−2.5))%
Principal Repayment at Maturity: 100%*[1+(300−X)/300]
One year later, if the index for Neighborhood ABC settles at 360 the principal will have a negative 20% return of loss.
One year later, if the index for Neighborhood ABC settles at 240 the principal will have a positive 20% return of profit.

Differential Returns Real Estate Index Derivative Products favoring Neighborhood ABC:
Notional Amount: Any Practical Minimum Amount
Currency: USD
Coupon: 2.5% (=4+(2−5)+(5−3.5))%
Principal Repayment at Maturity:
100%*[1+(X−300)/300+(600−Y)/600]
One year later, if the Neighborhood ABC index settles at 360 and DEF settles at 660 the principal will have a positive 10% return of profit.

Differential Returns Real Estate Index Derivative Products favoring Neighborhood DEF:
Notional Amount: Any Practical Minimum Amount
Currency: USD
Coupon: 4.5% (=4+(5−2.5)+(3−5))%
Principal Repayment at Maturity:
100%*[1+(300−X)/300+(Y−600)/600]
One year later, if the Neighborhood ABC index settles at 360 and DEF settles at 660 the principal will have a negative 10% return of loss.

The structures could be further leveraged in order to create more property price change impact to the degree that the principal amount will not be entirely eroded by marking-to-market during the holding period for prudent risk management practice by issuers. The risks inherent in property or real estate index linked notes, bonds or deposits could be hedged off through outright real estate index derivative product trading. For every property or real estate index linked note, bond or deposit structured and sold by the issuer, there will a matching or a matching combination exposure that could be offset entirely or partially by outright trading “first generation” real estate derivative financial products, appreciation give-up financial products, and/or depreciation protection financial products of the present invention with counter-party as well as forwards, options, TRS or PRS. This will be one way to hedge the component risks. Otherwise, the property or real estate index linked notes, bonds or deposits could simply be traded in the secondary market to lay off the position risks.

The structured notes could be created for incurring property value risk and return exposures using appreciation give-up financial products and depreciation protection financial products of the present invention. For the sake of the simplicity of illustration, a one-year maturity of non-leveraged structured note is used as non-limiting examples below, assuming the following additional current market conditions:
One Year Appreciation Give-Up Financial Product in Neighborhood ABC: −3.0%/−3.5%
One Year Depreciation Protection Financial Product in Neighborhood ABC: 10.5/10.0%
Property Price Index for Neighborhood ABC at the beginning of the year: 300
Property Price Index for Neighborhood ABC at the end of the year: 360 or 240

Note Buyer Bullish Appreciation Give-Up Financial Product:
Notional Amount: Any Practical Minimum Amount
Currency: USD
Coupon: −4.5% (=4+(−3.5−5))%
Principal Repayment at Maturity: Max<100%*[1+(X−300)/300],100%>
One year later, if the index for Neighborhood ABC settles at 360 the principal will have a positive 20% return of profit.
One year later, if the index for Neighborhood ABC settles at 240 the principal will remain unchanged at 100%.

Note Buyer Bearish Appreciation Give-Up Financial Product:
Notional Amount: Any Practical Minimum Amount
Currency: USD
Coupon: 12% (=4+(3.0+5))%
Principal Repayment at Maturity: Min<100%*[1−(X−300)/300],100%>
One year later, if the index for Neighborhood ABC settles at 360 the principal will have a negative 20% return of loss.
One year later, if the index for Neighborhood ABC settles at 240 the principal will remain unchanged at 100%.

Note Buyer Bearish Depreciation Protection Financial Product:
Notional Amount: Any Practical Minimum Amount
Currency: USD
Coupon: −1.5% (=4+(−10.5+5))%
Principal Repayment at Maturity: Max<100%*[1−(300−X)/300],100%>
One year later, if the index for Neighborhood ABC settles at 360 the principal will remain unchanged at 100%.
One year later, if the index for Neighborhood ABC settles at 240 the principal will have a positive 20% return of profit.

Note Buyer Bullish Depreciation Protection Financial Product:
Notional Amount: Any Practical Minimum Amount
Currency: USD
Coupon: 9% (=4+(10−5))%
Principal Repayment at Maturity: Min<100%*[1−(300−X)/300],100%>
One year later, if the index for Neighborhood ABC settles at 360 the principal will remain unchanged at 100%.
One year later, if the index for Neighborhood ABC settles at 240 the principal will have a negative 20% return of loss.

Further leverage, combinations or exotic structures such as for example quanto currency exposure, digital options pay-off, etc. are also possible variations. Property or real estate index linked notes, bonds or deposits could be marketed to both institutional and retail investors or to speculators with a view on the property or real estate markets either in a particular neighborhood, towns, cities, states, regions or countries depending on the indices used, as described below. Property or real estate index linked notes, bonds or deposits could also be marketed either to long hedgers (anticipatory hedge) who may be current renters in a particular neighborhood or to short hedgers who are currently already property owners in a particular neighborhood in a certain country.

As previously described, the real estate index of the present invention provides a transparent relationship that the combined granular smaller indices could be related to one larger broad level index. This helps the design for the related derivative instruments of the present invention. For example, one long interest of a broad level index built into an index linked structured investment products such as the property or real estate index linked notes, bonds or deposits of the present invention could be fungible or offset-able from the property value risk perspective with very little basis risk by the many retail short hedging interest exposures extracted from 200 or 300 index linked mortgage products of the present invention based on more granular lower level indices. The short hedging interests could also come from other similar structured investment products holding the opposite views and therefore short interest exposures on the more granular lower level indices either directly or in combinations.

### An Index Construction

In accordance with the principles of the present invention, a preferred, though not necessary, real estate index for pricing real estate index derivative products of the present invention can be provided. Further, in accordance with the principles of the present invention, a preferred, though not necessary, real estate index can also be provided that can be utilized for example in property index linked mortgages and structured investment products business. In particular, real estate indices of the present invention will be able to provide the lower level granular indices which offer higher hedging correlation normally required by the property owners and the higher level broad indices that are more convenient for derivatives trading and the index linked structured products created for investors and speculators. The real estate indices of the present invention will apply to both residential and commercial real estates.

In accordance with the principles of the present invention, the real estate index of the present invention provides a transparent relationship that the combined granular smaller indices could be related to one larger broad level index. This will make the index more suitable for index derivatives trading. This will also help the design for the real estate index derivative products and the related derivative instruments of the present invention. In one embodiment, the real estate index derivative product could be based on indices which are comprised of per square area weighted average or median price information for each combination of postal code regions.

The real estate index of the present invention will be able to drill down to the small homogeneous groups or neighborhoods of like kind properties that could be defined either by ZIP code in the US, postal codes in many other countries, or housing developments or suburbs in other countries. The real estate index of the present invention could also be able to drill down other smaller possible neighborhood elements defined by other unconventional methodologies such as census collection districts, electoral council area and satellite geo-spatial image area of like kind property structures, etc. The real estate index of the present invention could also be easily scaled up to a larger broad level index by combining smaller indices and simply going through the same transparent weighted average relationship in order to cover much larger geographical area with more number of properties.

Whether at a national, a regional or a neighborhood level, covering either a large or small area, the real estate indices of the present invention could be determined as a rolling moving average price to avoid potential manipulation or extraordinary events. More sophisticated statistical methods could also be employed if enough data points are available to further smooth the data to provide the more relevant indicative power of such indices. This rolling moving average method can also provide a more frequently updated index level for derivatives trading as well as for the daily settlements of index linked mortgage products and index linked investment structured products. Therefore, these property derivatives trading and structured mortgage or investment products could easily be marked-to-market on a daily basis which will be very useful for the required risk management practice of banks or other investment funds. This feature will greatly promote the popularity of use and hence the liquidity of these indices based financial products.

In the U.S., the ZIP (Zone Improvement Plan) codes are a developed and convenient form of describing neighborhoods for the postal service. The ZIP code methodology has been well accepted in various parts of our daily life. The most important value of using ZIP code oriented index is that it is easily understood and accepted by property owners as they can identify which neighborhoods they belong to by the ZIP codes. In regions outside the U.S., comparable postal codes, housing developments or suburbs to which property owners relate can be utilized.

For example, if the basic neighborhood element of a ZIP code (or postal code in countries other than US) is used to create the per square foot (or meter) property weighted average price information, a much bigger region can be scaled up and expanded to by simply including more than one ZIP code (postal code) in the same weight averaging relationship. Examples of potential broad indices are U.S.A., East Coast, New York Tri-State, California, Bay Area, SoCal or going down to more specific lower levels, Newport Beach Single Family Houses, Santa Monica Condos or even ZIP code specific indices, 90210, 92879, etc. if the more precise single ZIP code neighborhood have enough potential users for the real estate index derivative products of the present invention or other structured derivative contracts. It could be quite normal that each of the popular indices created in accordance with the present invention will be composed of more than one ZIP code and most likely it could be at a town level composed of 5 to 10 ZIP codes of neighborhoods. So the desirable index size for the real estate index derivative products of the present invention or other property derivatives trading could be determined by a balance between the requirement for hedge ratio by the hedging property owners and the commercially viability of liquidity concerns for such derivatives products and the index linked structured mortgage or index linked investment products. Examples for commercial properties could be Office Mid-town Manhattan, Apartment West Los Angeles, Hotel Miami, Warehouse Chicago, Retail Metropolitan NYC, etc.

As previously mentioned, construction of the real estate indices of the present invention could be based on a weighted average of per square area (foot, meter, etc.) prices adjusted by property attributes within the neighborhood. This weighting can be based on the square area to produce the capital value of the like-kind properties selected in the smallest defined neighborhood area. Once the smallest identifiable neighborhood areas are defined and determined, the larger area indices can be created using the same weighted averaging methodology without further adjustment in a bottom-up approach to reach the higher broader levels and all the way up to a national level index.

Since the real estate indices of the present invention could be determined on a rolling moving average basis, as the new transactions happen each day, even with a time delay to account for the official recording and registration process, the indices will be able to provide a new value each day on a rolling basis, unless there are no new transactions during the entire sequential days used for the moving average calculation within the defined neighborhood or region. In that extreme case the index for that neighborhood can simply stay unchanged for that day.

During a properties selection process, representative properties will be selected to represent that particular neighborhood. As much as possible the data will be comprehensive to cover the stable properties in a neighborhood, but unstable outliers could be excluded so that less index revision will be necessary in the future. As new housing developments are established and old neighborhoods are destroyed by fire or other natural disasters within the neighborhood, the new properties can be either added or deleted accordingly in future index revisions.

The captured changes in transaction prices of the properties within a neighborhood can be adjusted for by its quantified property attributes. The property attributes could be as broad as characteristics such as the types of properties (for example condos, town homes, single family houses, etc.) if there are not enough to be treated separately in another defined neighborhood of like-kind properties, or down to other individual property characteristics such as for example square footage, year built, number of bedrooms/bathrooms, number of garages/swimming pools, lot sizes, views, ocean/lake front, high floors/low floors, distance to shopping centers and school districts, crime statistics, etc.

A property attributes adjustment process can smooth the changes in the individual neighborhood index between time periods to account for the fact that different properties with different attributes may have different volatility than the rest in a rising or a declining market. This way the index created for the smallest defining neighborhood will be an index that can reflect a group of quasi-homogeneous properties without disturbances of either uneven volatilities between properties with different attributes or the compositional changes through time in the neighborhood.

Once the smallest neighborhoods in a country are defined and determined, they will represent the lowest level to which the set of indices can drill down. When scaling up, the square footage weight averaged indices of larger neighborhoods, towns, cities, states, regions, and eventually national level can easily be created in this bottom up approach. The total capital value of all the selected property stocks within an area could be arrived by simply multiplying the total square footage of that area with the aggregated per square foot index of that particular area. These indices thus created would carry special meanings to investors and other financial market participants. For example, investors can simply continue to use the square foot (meter or other measures) to decide how much to invest in a particular area, in the same conventional way they conduct the underlying cash market real estate property investments. The indices could also be sliced and diced to accommodate for all kinds of research, analysis, derivatives trading, index linked mortgages and structured products settlements, etc. that are either currently available or to be created in possible future innovations.

As previously described, the real estate index of the present invention provides a transparent relationship that the combined granular smaller indices could be related to one larger broad level index. This helps the design for the related derivative instruments of the present invention. For example, the retail short hedging interest exposures extracted from 200 or 300 index linked mortgage products of the present invention could be fungible or offset-able from the property value risk perspective with very little basis risk by one large long interest in a broad level index of trading real estate index derivative products of the present invention.

For commercial properties, the smallest neighborhood of like-kind properties could be defined as groups of offices, retails shops, apartment complexes, industrial warehouses, and hotels in a specific area of a city. Else wise the real estate indices of the present invention for commercial properties could be very similar to the real estate indices of the present invention for residential properties.

The following are non-limiting simple examples of real estate index derivative products of the present invention (with 20 basis point example spread):

Assume a 3 month LIBOR at 3% in August 2002. The size is 1 square foot. The cash index for ZIP code comprised region 92879 is 135 in August, 2002; the cash index for 92860 is 155 in August, 2002; and the cash index for 91210 is 875 in August, 2002. The bid and offer for a 2-year real estate index derivative product could be quoted as SR2: 2.5%/2.3%, to be cash-settled on quarterly basis in order to mark-to-market the collateral; however, the real estate index derivative product could be unwound before maturity at any time after the initial establishment of the position. There can be a minimum (for example, 20 basis points) spread for each real estate index derivative product of different maturities or of different ZIP code comprised regions for either the brokerage format or the exchange format.

For a 3000 square foot house, a hedger needs 3000 real estate index derivative products. Assume one year later the cash indices are 92879 at 115; 92860 at 125; and 90210 at 655. The 3 month LIBOR could be trading at 4% in August 2003. The bid and offer for a 1-year real estate index derivative product could be quoted as SR1: 3.8%/3.6%. For ZIP code area 92879, the sample transactions for the hedger would be:
Notional value hedged: 3,000*$135=$405,000
Value drops to 3,000*$115=$345,000
Property value lost=−$60,000
Index value holding period capital returns=−(115−135)/135 hedged=−14.81%
Plus one year of 4 quarterly 3 Month LIBOR committed to receive at August 2002, assumed constant through the year at 3%—the 2-Y, SR2 committed to pay, 2.5%=0.5%
Plus the new unwinding 1-Y, SR1 trade committed to receive at August 2003, 3.6%—previous 2-Y SR2 committed to pay for another one more year, 2.5%=1.1%
Total value hedged=capital returns+income+unwinding cost=(405,000)*(14.81%+0.5%+1.1%)=66,460.50
Total loss for the investor=capital returns+income+unwinding cost=(405,000)*(−14.81%−0.7%−1.5%)=68,890.50

For ZIP code area 92860, the sample transactions for the hedger would be:
Notional value hedged: 3,000*$155=$465,000
Value drops to 3,000*$125=$375,000
Property value lost=−$90,000
Index value holding period capital returns=−(125−155)/155 hedged=−19.35%
Plus one year of 4 quarterly 3 Month LIBOR committed to receive at August 2002, assumed constant through the year at 3%—the 2-Y, SR2 committed to pay, 2.5%=0.5%
Plus the new unwinding 1-Y, SR1 trade committed to receive at August 2003, 3.6%—previous 2-y SR2 committed to pay for another one more year, 2.5%=1.1%
Total value hedged=capita 1 returns+income+unwinding cost=(465,000)*(19.35%+0.5%+1.1%)=97,417.50
Total loss for the investor=capital returns+income+unwinding cost=(465,000)*(−19.35%−0.7%−1.5%)=−100,207.50

For ZIP code area 90210, the sample transactions for the hedger would be:
Notional value hedged: 3,000*$875=$2,625,000
Value drops to 3,000×$655=$1,965,000
Property value lost=−$660,000
Index value holding period capital returns=−(665−875)/875 hedged=−24.00%
Plus one year of 4 quarterly 3 Month LIBOR committed to receive at August 2002, assumed constant through the year at 3%—the 2-Y, SR2 committed to pay, 2.5%=0.5%
Plus the new unwinding 1-Y, SR1 trade committed to receive at August 2003, 3.6%—previous 2-y SR2 committed to pay for another one more year, 2.5%=1.1%
Total value hedged=capita 1 returns+income+unwinding cost=(2,625,000)*(24%+0.5%+1.1%)=672,000
Total loss for the investor=capital returns+income+unwinding cost=(2,625,000)*(−24%−0.7%−1.5%)=−687,750.00

In the three non-limiting examples above, revenue could be generated from spread between bid and offer of products traded, in these examples, using a non-limiting minimum 20 basis point profit on each initial and unwinding trade (in and out):
For ZIP code 92879=2*0.2%*$405,000=2*$810=$1,620
For ZIP code 92860=2*0.2%*$465,000=2*$930=$1,860
For ZIP code 90210=2*0.2%*$2,625,000=2*$5,250=$10,500

### Example Hardware and Methodology

Referring to FIG. 5, a non-limiting example of a network hardware infrastructure that can be used to run the real estate derivative financial products, index design, and trading methods of the present invention is seen. The architecture conforms to a distributed Internet-based architecture using object oriented principles useful in carrying out the methods of the present invention.

A central controller 100 has a plurality software and hardware components and is embodied as a mainframe computer or a plurality of workstations. The central controller 100 is preferably located in a facility that has back-up power, disaster-recovery capabilities, and other similar infrastructure, and is connected via telecommunications links 110 with via a TI cable modem 120, an intranet VPN 130, a wide area network such as the Internet 140, wireless communication 150, and the like. Signals transmitted using telecommunications links 110, can be encrypted by public and private key encryption. Other telecommunications links, such as radio transmission, are known to those of skill in the art.

To establish telecommunications connections with the central controller 100, a property owner or investor can use for example a desktop computer 160. In preferred embodiments, the computers used by property owner or investor can be run on a PC having a minimum of Windows 98 or higher (e.g., Windows2000 or WindowsXP), the equivalent of a Pentium III processor available from Intel Corporation, 2200 Mission College Boulevard, Santa Clara, Calif. or higher, and a speed of 600 MHz or faster. A property owner or investor can also use a notebook computer 170, personal digital assistant 180, a mobile phone 190, personal digital assistant 200, and the like.

In one aspect of the present invention, the real estate derivative financial products, index design, and trading methods of the present invention can form the basis for development of a new industry. The different pieces of the industry could be truncated and each of the businesses could be run by different entities. For example, the index compiler/publisher, the commercial banks, the investment banks, the IDBs, the REIDeX.com, and the SwapRent.com each can be a different participant in the new industry.

Referring to FIG. 5, a flow chart of one preferred, non-limiting example of a method of the creation of such an industry in accordance with the principles of the present invention is seen. This method can be implemented on for example the non-limiting example of network hardware infrastructure described above. Initially, a real estate index can be provided as described in detail above with conjunction to the section entitled “The Index Construction”. The basic smallest definable neighborhood element of like kind properties such as a ZIP code (or postal code in countries other than US) or a housing development project can be used to create the per square foot (or meter) property weighted average price information. If this basic neighborhood element represents too small of a geographic area, then a bigger region can be scaled up and expanded to by simply including more than one smallest definable neighborhood of the like kind properties such as a ZIP code (postal code) or a housing development project in the same weight averaging relationship.

Once the index has been constructed, real estate derivative financial products can be provided. These can include “first generation” real estate derivative financial products as described in detail above with conjunction to the section entitled “SwapRent^{SM}”. Again, these may be offered by a different entity from the real estate index of the present invention. Additionally, if end-user property owners are interested in optionality, variations of different levels of trading of the synthetic “rents” of the financial products of the present invention can be provided as described in detail above with conjunction to the section entitled “REIO”. Again, these may be offered by a different entity from the real estate index and the “first generation” real estate derivative financial products of the present invention. In addition, options and forwards trading products as described in detail above with conjunction to the section entitled “OTC Options and Forwards” could be provided. Again, these may be offered by a different entity from the real estate index, the “first generation” real estate derivative financial products, and the “REIO” of the present invention.

If financial institutions are interested in offering to residential property owners or to commercial real estate property owners, new mortgage products can be provided as described in detail above with conjunction to the sections entitled “PELM”, “HELM”, and “FVCM”. Again, these may be offered by a different entity from the real estate index, the “first generation” real estate derivative financial products, the “REIO” and the “OTC Options and Forwards” of the present invention. Additionally, structured investment products can be provided for incurring property value risk and return exposures as described in detail above with conjunction to the section entitled “PILN” and “REILD”. Again, these may be offered by a different entity from the real estate index, the “first generation” real estate derivative financial products, the “REIO”, the “OTC Options and Forwards”, the “PELM”, the “HELM”, and the “FVCM” of the present invention.

Next, a decision on whether to offer on-line trading is made. If yes, then a trading forum can be provided as described in detail above with conjunction to the section entitled “REIDeX.com”. An Internet portal site can serves as an on-line exchange that offers price indications and execution capabilities for buyers and sellers of the real estate index derivative products of the present invention. Again, on-line trading of the present invention may be offered by a different entity from the real estate index, the “first generation” real estate derivative financial products, the “REIO”, the “OTC Options and Forwards”, the “PELM”, the “HELM”, the “FVCM”, the “PILN”, and the “REILD of the present invention.

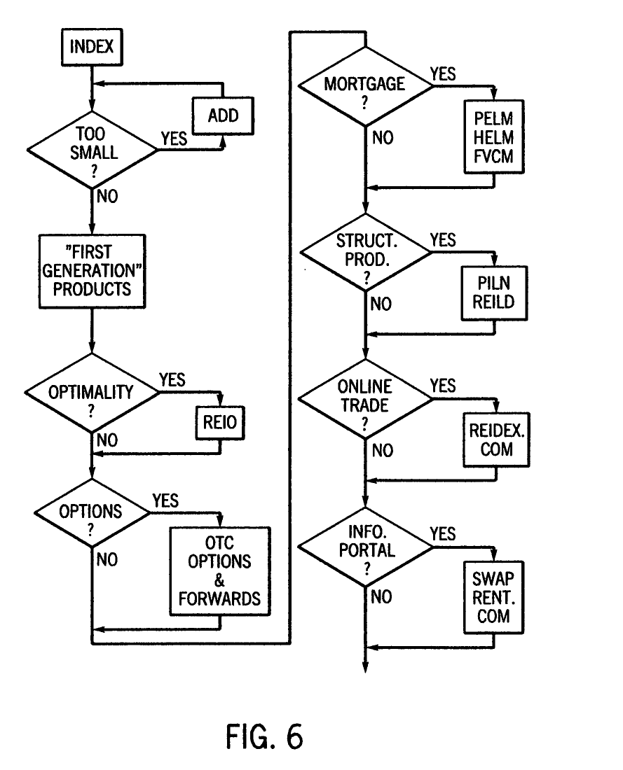

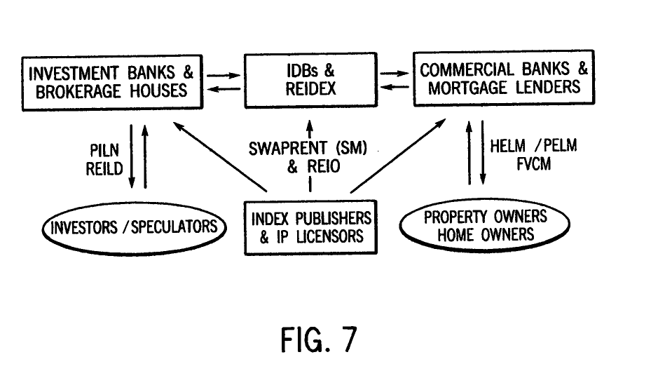

Next, a decision on whether to offer on-line trading information is made. If yes, then an information forum can be provided as described in detail above with conjunction to the section entitled “SwapRent.com”. The information forum can display price information of the various last trade information of the “first generation” real estate derivative financial products, the appreciation give-up financial products, and the depreciation protection financial products of the present invention as well as other generic swaps, forwards, options, and swaptions contracts on real estate indices. Again, an Internet portal site can serve as an on-line forum that offers last trades information of the real estate index derivative products of the present invention. Again, on-line trading information of the present invention may be offered by a different entity from the real estate index, the “first generation” real estate derivative financial products, the “REIO”, the “OTC Options and Forwards”, the “PELM”, the “HELM”, the “FVCM”, the “PILN”, the “REILD and the on-line trading of the present invention. Thus, if all of the pieces described above are implemented, a new industry as reflected in FIG. 6 could develop with various interdependent players cooperating for the mutual benefit of the marketplace. Of course, the principles of the present invention should not be interpreted as limited to this “ultimate” implementation.

While the invention has been described with specific embodiments, other alternatives, modifications and variations will be apparent to those skilled in the art. For example, while the present invention has been primarily described in conjunction with residential real estate, the same principles apply to commercial real estate. Accordingly, it will be intended to include all such alternatives, modifications and variations set forth within the spirit and scope of the appended claims.

1. A real estate derivative product comprising a synthetic “rent” in real estate that enables a property owner to lock in property equity value for a period of time, while continuing existing legal real estate ownership.

2. The real estate derivative product of claim 1 further comprising a derivative product that utilizes price indices to correlate to the underlying real estate property market.

3. The real estate derivative product of claim 2 further wherein the price indices comprises smallest definable like-kind property neighborhoods and their aggregates based per square area real estate weighted average index.

4. The real estate derivative product of claim 3 further wherein the price indices comprises a postal-code based per square area real estate weighted average index.

5. The real estate derivative product of claim 2 further wherein the price indices comprises a postal-code based per square area real estate median price index.

6. The real estate derivative product of claim 1 further wherein an investor pays the property owner and, if the property value rises representing a gain, the gain belongs to the investor.

7. The real estate derivative product of claim 6 further wherein the property owner pays the investor and, if the property value decreases representing a loss, then the loss is incurred by the investor.

8. The real estate derivative product of claim 1 further including further derivative financial instruments based thereon.

9. The real estate derivative product of claim 1 further including further derivative financial instruments based thereon selected from the group comprising index linked notes, index linked bonds, index linked deposits, and combinations thereof.

10. The real estate derivative product of claim 1 further wherein the real estate index derivative product is quoted.

11. The real estate derivative product of claim 1 further wherein the real estate index derivative product is traded.

12. A real estate derivative product comprising an investor being exposed to property equity value for a period of time by creating a synthetic long position in real estate, without requiring legal real estate ownership.

13. The real estate derivative product of claim 12 further comprising a derivative product that utilizes price indices to correlate to the underlying real estate property market.

14. The real estate derivative product of claim 13 further wherein the price indices comprises smallest definable like-kind property neighborhoods and their aggregates based per square area real estate weighted average index.

15. The real estate derivative product of claim 14 further wherein the price indices comprises a postal-code based per square area real estate weighted average index.

16. The real estate derivative product of claim 13 further wherein the price indices comprises a postal-code based per square area real estate median price index.

17. The real estate derivative product of claim 12 further wherein a property owner pays the investor and, if the property value decreases representing a loss, then the loss is incurred by the investor.

18. The real estate derivative product of claim 12 further wherein the investor pays the property owner and, if the property value rises representing a gain, the gain belongs to the investor.

19. The real estate derivative product of claim 12 further including further derivative financial instruments based thereon.

20. The real estate derivative product of claim 12 further including further derivative financial instruments based thereon selected from the group comprising index linked notes, index linked bonds, index linked deposits, and combinations thereof.

21. The real estate derivative product of claim 12 further wherein the real estate index derivative product is quoted.

22. The real estate derivative product of claim 12 further wherein the real estate index derivative product is traded.

23. A real estate derivative product comprising a derivative product that utilizes price indices to correlate to underlying real estate property market.

24. The real estate derivative product of claim 23 further wherein the price indices are created based on smallest definable neighborhoods of like-kind properties and their aggregates.

25. The real estate derivative product of claim 24 further wherein the price indices are created based on smallest identifiable neighborhood postal-code based per square area real estate weighted average index.

26. The real estate derivative product of claim 24 further wherein the price indices are created based on smallest identifiable neighborhood postal-code based per square area real estate median price index.

27. The real estate derivative product of claim 23 further including a funding cost expressed as a floating interest rate.

28. The real estate derivative product of claim 27 further including a funding cost expressed as a floating interest rate such as a London Inter-Bank Offered Rate (LIBOR).

29. The real estate derivative product of claim 23 further including a funding cost expressed as a fixed interest rate.

30. The real estate derivative product of claim 29 further including a funding cost expressed as a fixed interest rate such as an interest rate swap rate.

31. The real estate derivative product of claim 23 further wherein a property owner pays an investor; the investor pays the property owner; if the property value rises representing a gain, the gain belongs to the investor; and if the property value decreases representing a loss, then the property owner will be paid by the investor for the loss.

32. The real estate derivative product of claim 23 further including further derivative financial instruments based thereon.

33. The real estate derivative product of claim 23 further including derivative financial instruments are selected from the group comprising a total return swap, a price return swap, a forward, an option, a real estate index derivative product that utilizes price indices to correlate to the underlying market real estate properties, and combinations thereof.

34. The real estate derivative product of claim 23 further including further derivative financial instruments based thereon selected from the group comprising index linked notes, index linked bonds, index linked deposits, and combinations thereof.

35. The real estate derivative product of claim 23 further wherein the real estate index derivative product is quoted.

36. The real estate derivative product of claim 23 further wherein the real estate index derivative product is traded.

37. A real estate derivative structure comprising:
a property owner paying an investor;
the investor paying the property owner;
if the property value rises representing a gain, the gain belongs to the investor; and
if the property value decreases representing a loss, then the property owner will be paid by the investor for the loss;
such that the property owner will be protected from fluctuations of the property value.

38. The real estate derivative structure of claim 37 further including a funding cost comprised of a floating interest rate.

39. The real estate derivative structure of claim 38 further including a funding cost comprised of a floating interest rates such as a London Inter-Bank Offered Rate (LIBOR).

40. The real estate derivative structure of claim 37 further including a funding cost comprised of a fixed interest rate.

41. The real estate derivative structure of claim 40 further including a funding cost comprised of a fixed interest rate such as an interest rate swap rate for a certain maturity.

42. The real estate derivative structure of claim 37 further wherein the payment of the property owner and the payment of the investor are offset and netted out.

43. The real estate derivative structure of claim 37 further wherein the value of the property is determined through an appraised value.

44. The real estate derivative structure of claim 37 further wherein the value of the property is determined through a real estate price index.

45. The real estate derivative structure of claim 44 further wherein the value of the property is determined through a smallest identifiable neighborhood postal-code based per square area real estate index and their aggregates.

46. The real estate derivative structure of claim 37 further including a real estate index derivative product expressed an annualized percentage, but determined by multiplying a property value and prorating the property value for periodic payment amount.

47. The real estate derivative structure of claim 46 further wherein the real estate index derivative product is quoted.

48. The real estate derivative structure of claim 46 further wherein the real estate index derivative product is traded.

49. The real estate derivative structure of claim 37 further including further derivative financial instruments based thereon.

50. The real estate derivative structure of claim 37 further including further derivative financial instruments based thereon selected from the group comprising index linked notes, index linked bonds, index linked deposits, and combinations thereof.

51. A real estate derivative structure comprising:
an investor paying a property owner; and
if the property value rises representing a gain, then the gain belongs to the investor;
such that the property owner receives the payment regardless of whether a gain is realized.

52. The real estate derivative structure of claim 51 further wherein the property owner provides an offset against the property owner payment while avoiding risk of property depreciation.

53. The real estate derivative product of claim 52 further wherein notional amounts of the property owner payment and the offset payments are the same.

54. The real estate derivative product of claim 52 further wherein notional amounts of the property owner payment and the offset are the not the same.

55. The real estate derivative product of claim 52 further wherein starting dates for the property owner payment and the offset are the same.

56. The real estate derivative product of claim 52 further wherein starting dates for the property owner payment and the offset are not the same.

57. The real estate derivative product of claim 52 further wherein maturity dates for the property owner payment and the offset are the same.

58. The real estate derivative product of claim 52 further wherein maturity dates for the property owner payment and the offset are not the same.

59. The real estate derivative product of claim 52 further wherein starting values for the property owner payment and the offset are the same.

60. The real estate derivative product of claim 52 further wherein starting values for the property owner payment and the offset are not the same.

61. The real estate derivative structure of claim 51 further including a funding cost comprised of a floating interest rate.

62. The real estate derivative structure of claim 61 further including a funding cost comprised of a floating interest rate such as a London Inter-Bank Offered Rate (LIBOR).

63. The real estate derivative structure of claim 51 further including a funding cost comprised of a fixed interest rate.

64. The real estate derivative structure of claim 51 further including a funding cost comprised of a fixed interest rate such as an interest rate swap rate.

65. The real estate derivative structure of claim 51 further wherein the value of the property is determined through real appraised value.

66. The real estate derivative structure of claim 51 further wherein the value of the property is determined through a real estate price index.

67. The real estate derivative structure of claim 66 further wherein the value of the property is determined through a smallest identifiable neighborhood postal-code based per square area real estate index and their aggregates.

68. The real estate derivative structure of claim 51 further including a real estate index derivative product expressed an annualized percentage, but determined by multiplying a property value and prorating the property value for periodic payment amount.

69. The real estate derivative structure of claim 68 further wherein the real estate index derivative product is quoted.

70. The real estate derivative structure of claim 68 further wherein the real estate index derivative product is traded.

71. The real estate derivative structure of claim 51 further including further derivative financial instruments based thereon.

72. The real estate derivative structure of claim 51 further including further derivative financial instruments based thereon selected from the group comprising index linked notes, index linked bonds, index linked deposits, and combinations thereof.

73. A real estate derivative structure comprising:
a property owner paying an investor; and
if the property value decreases representing a loss, then the property owner will be paid by the investor for the loss;
such that the property owner will be protected from property value decreases.

74. The real estate derivative structure of claim 73 further wherein the investor provides an offset against the investor payment while benefiting from risk of property appreciation.

75. The real estate derivative product of claim 74 further wherein notional amounts of the investor payment and the offset are the same.

76. The real estate derivative product of claim 74 further wherein notional amounts of the investor payment and the offset are not the same.

77. The real estate derivative product of claim 74 further wherein starting dates for the investor payment and the offset are the same.

78. The real estate derivative product of claim 74 further wherein starting dates for the investor payment and the offset are not the same.

79. The real estate derivative product of claim 74 further wherein maturity dates for the investor payment and the offset are the same.

80. The real estate derivative product of claim 74 further wherein maturity dates for the investor payment and the offset are not the same.

81. The real estate derivative product of claim 74 further wherein starting values for the investor payment and the offset are the same.

82. The real estate derivative product of claim 74 further wherein starting values for the investor payment and the offset are not the same.

83. The real estate derivative structure of claim 73 further including a funding cost comprised of a floating interest rate.

84. The real estate derivative structure of claim 73 further including a funding cost comprised of a floating interest rates such as a London Inter-Bank Offered Rate (LIBOR).

85. The real estate derivative structure of claim 73 further including a funding cost comprised of a fixed interest rate.

86. The real estate derivative structure of claim 73 further including a funding cost comprised of a fixed interest rates such as an interest rate swap rate.

87. The real estate derivative structure of claim 73 further wherein the value of the property is determined through real appraised value.

88. The real estate derivative structure of claim 73 further wherein the value of the property is determined through a real estate price index.

89. The real estate derivative structure of claim 88 further wherein the value of the property is determined through a smallest identifiable neighborhood postal-code based per square area real estate index and their aggregates.

90. The real estate derivative structure of claim 73 further including a real estate index derivative product expressed an annualized percentage, but determined by multiplying a property value and prorating the property value for periodic payment amount.

91. The real estate derivative structure of claim 90 further wherein the real estate index derivative product is quoted.

92. The real estate derivative structure of claim 90 further wherein the real estate index derivative product is traded.

93. The real estate derivative structure of claim 73 further including further derivative financial instruments based thereon.

94. The real estate derivative structure of claim 73 further including further derivative financial instruments based thereon selected from the group comprising index linked notes, index linked bonds, index linked deposits, and combinations thereof.

95. A real estate price index comprising a group of smallest identifiable neighborhood of like kind properties per square area real estate price index having sufficient correlation to hedge the beta of the property value risk, but not the alpha and their layers of aggregates.

96. The real estate price index of claim 95 further including a smallest identifiable neighborhood of like kind properties per square area real estate weighted average price index having sufficient correlation to hedge the beta of the property value risk, but not the alpha.

97. The real estate price index of claim 95 further including a smallest identifiable neighborhood of like kind properties per square area real estate median price index having sufficient correlation to hedge the beta of the property value risk, but not the alpha.

98. The real estate price index of claim 95 further wherein the smallest identifiable neighborhood of like kind properties per square area real estate price index comprises a postal-code based per square foot real estate price index.

99. The real estate price index of claim 98 further wherein the postal-code based per square area real estate price index comprises a Zone Improvement Plan code based per square foot real estate price index.

100. The real estate price index of claim 95 further wherein the smallest identifiable neighborhood of like kind properties per square area real estate price index comprises at least one smallest identifiable neighborhood of like kind properties.

101. The real estate price index of claim 95 further wherein the smallest identifiable neighborhood of like kind properties per square area real estate price index comprises more than one smallest identifiable neighborhood of like kind properties.

102. The real estate price index of claim 95 further wherein the price index comprises a rolling moving average of the price index.

103. The real estate price index of claim 102 further wherein the price index comprises a rolling moving average of the weighted average price index.

104. The real estate price index of claim 102 further wherein the price index comprises a rolling moving average of the median price index.

105. The real estate price index of claim 95 further wherein the real estate price index is utilized for pricing a real estate index derivative product.

106. The real estate price index of claim 105 further wherein the real estate price index is utilized for pricing for a real estate index derivative product that enables property owners to lock in property equity value for a period of time by creating a synthetic “rent” position in real estate, while continuing existing legal real estate ownership.

107. The real estate price index of claim 105 further wherein the real estate price index is utilized for pricing for a real estate index derivative product that enables investors to establish an exposure in property equity value for a period of time by creating a synthetic long position in real estate, without requiring legal real estate ownership.

108. The real estate price index of claim 95 further wherein the real estate price index comprises a geographic area and a type of real estate.

109. The real estate price index of claim 108 further wherein the real estate price index comprises a geographic area and a type of residential real estate.

110. The real estate price index of claim 108 further wherein the real estate price index comprises a geographic area and a type of commercial real estate.

111. The real estate price index of claim 95 further wherein the real estate price index is further adjusted by property attributes within the neighborhood.

112. The real estate price index of claim 95 further including adjusting for quantified property attributes.

113. The real estate price index of claim 112 further including adjusting for types of properties.

114. The real estate price index of claim 112 further including adjusting for individual property characteristics.

115. The real estate price index of claim 95 further including excluding unstable outlier properties.

116. A mortgage product comprising a borrower giving a lender the right to use an equity portion of an underlying property for real estate derivatives transactions where periodic mark-to-market activities will either increase or decrease the property equity amount.

117. The mortgage product of claim 116 further wherein the derivative products are selected from the group comprising a total return swap, a price return swap, a forward, an option, a real estate index derivative product that utilizes price indices to correlate to the underlying market real estate properties, and combinations thereof.

118. The mortgage product of claim 116 further wherein a property owner who gives up potential upside appreciation property value gain, acquires downside depreciation protection for potential property value loss or both in a property through derivative transactions; a property value-gain lost and paid out to a derivative counterparty reflected as an increase of a borrowing amount; and a property value-loss gained and paid out by a derivative counterparty reflected as a decrease of the borrowing amount; such that the borrowing amount will fluctuate up and down in tandem with the asset value of the property.

119. The mortgage product of claim 118 further wherein the mortgage payments change to interest only when the property asset value increases as the borrowing amount increases.

120. The mortgage product of claim 118 further wherein the mortgage payments include an amortization amount when the property asset value declines as the borrowing amount decreases.
